(19) United States
(12) Patent Application Publication
(10) Pub. No.: US 2007/0071104 A1
(43) Pub. Date: Mar. 29, 2007

(54) Picture coding method and picture decoding method

(76) Inventor: Satoshi Kondo, Kyoto (JP)

Correspondence Address: WENDEROTH, LIND & PONACK L.L.P., 2033 K. STREET, NW, SUITE 800, WASHINGTON, DC, 20006, US

(21) Appl. No.: 11/527,509

(22) Filed: Sep. 27, 2006

(30) Foreign Application Priority Data
Sep. 28, 2005 (JP) 2005-282851

(51) Int. Cl. H04N 11/02; H04N 7/12

(52) U.S. Cl. 375/240.21; 375/240.26

(57) ABSTRACT

A picture coding device has: a coding controlling unit which decides whether or not a to-be-coded picture is to be coded as a high-resolution picture or a low-resolution picture, depending on a picture type of the to-be-coded picture; the first down-conversion unit which down-converts resolution of the to-be-coded picture, when the to-be-coded picture is decided to be coded as a low-resolution picture; the second down-conversion unit which down-converts resolution of a reference picture, when the reference picture is referred to by the to-be-coded picture decided to be coded as a low-resolution picture; and a motion estimation unit, a mode selection unit, a difference operation unit, and a residual coding unit which code the to-be-coded picture whose resolution is down-converted by the first down-conversion unit, referring to the reference picture whose resolution is down-converted by the second down-conversion unit.

### BACKGROUND OF THE INVENTION

(1) Field of the Invention

The present invention relates to a picture processing method of generating a high-resolution picture from a low-resolution picture, using motion between the low-resolution picture and another low-resolution picture to which the former low-resolution picture refers, and also relates to a picture coding method and a picture decoding method for high-efficient compression coding using the picture processing method.

(2) Description of the Related Art

In conventional picture coding methods represented by a MPEG video coding system, a picture is segmented into parts on a predetermined data unit basis, and coding is applied per data unit. For example, in MPEG-4 AVC (Advanced Video Coding) method as disclosed in document “ISO/IEC 14496-10 MPEG-4 Advanced Video Coding Standards”, a picture is segmented into data units called macroblocks, each having 16×16 pixels, and coding processing is performed on a macroblock-by-macroblock basis. Then, for motion compensation, one macroblock is further segmented into rectangular blocks, each having 4×4 pixels at minimum, and motion compensation is performed using each motion vector on a block-by-block basis.

Thus, by performing motion compensation using motion vectors which differ depending on each block, and by increasing the number of pictures to which each block can refer, it is possible to encode and decode pictures having higher resolution.

However, in the above conventional methods, it is necessary, regarding more blocks, to code additional information, such as a motion vector for each block, and information indicating which picture is referred to by each block. As a result, the conventional methods have a problem of difficulty in reducing a coding amount of a high-resolution picture, when the high-resolution picture is to be coded without deterioration of image quality.

### SUMMARY OF THE INVENTION

In order to solve the above problem, an object of the present invention is to provide a picture coding method and a picture decoding method, by which an input picture can be efficiently coded with a coding amount significantly reduced.

In order to achieve the object, the picture coding method according to the present invention codes a high-resolution input picture to be one of a high-resolution picture and a low-resolution picture. The picture coding method includes: deciding whether or not a to-be-coded picture is to be coded as a high-resolution picture or a low-resolution picture, depending on a picture type of the to-be-coded picture; down-converting resolution of the to-be-coded picture, when the to-be-coded picture is decided to be coded as a low-resolution picture in the deciding; down-converting resolution of a reference picture which has been coded as a high-resolution picture, when the reference picture is referred to by the to-be-coded picture decided to be coded as a low-resolution picture in the deciding; and coding the to-be-coded picture whose resolution is down-converted in the down-converting of the resolution of the to-be-coded picture, referring to the reference picture whose resolution is down-converted in the down-converting of the resolution of the reference picture.

Further, in the deciding, it may be decided that an I-picture and a P-picture are coded as high-resolution pictures, and a B-picture is coded as a low-resolution picture, assuming that the B-picture is not referred to by any other pictures.

Furthermore, in the deciding, it may be decided that only I-picture is coded as a high-resolution picture.

Still further, the picture coding method may further include up-converting resolution of a reference picture which has been coded as a low-resolution picture, when the reference picture is referred to by the to-be-coded picture decided to be coded as a high-resolution picture in the deciding, wherein, in the coding, the to-be-coded picture refers to the reference picture whose resolution is up-converted in the up-converting.

Still further, the up-converting may include: estimating a motion vector, per one or more pixels, for a first low-resolution picture from a second low-resolution picture, the first low-resolution picture being the reference picture of to-be-coded picture and coded as a low-resolution picture, and the second low-resolution picture being a reference picture of the first low-resolution picture in the coding of the first low-resolution picture; obtaining, based on the estimated motion vector, a first pixel value of a pixel in a second high-resolution picture which corresponds to the pixel used in the estimating, the second high-resolution picture representing the same image as the second low-resolution picture but having different resolution; and generating a first high-resolution picture, by using the obtained first pixel value, in order to be used as the actual reference picture of the to-be-coded picture, the first high-resolution picture representing the same image as the first low-resolution picture but having different resolution.

Still further, the up-converting may further include: estimating a motion vector for the first high-resolution picture from the second high-resolution picture, per one or more pixels each of which has been already generated in the first high-resolution picture; obtaining, based on the estimated motion vector, a second pixel value of a pixel in the second high-resolution picture which is positioned at the same location as the pixel in the first high-resolution picture; and generating the first high-resolution picture, by using the an average value of the obtained first and second pixel values in a corresponding pixel, in order to be used as the actual reference picture of the to-be-coded picture.

Still further, the up-converting may further include: estimating a plurality of motion vectors, regarding already-generated pixels, for the first low-resolution picture from a plurality of the second low-resolution pictures, and for the first high-resolution picture from a plurality of the second high-resolution pictures; and generates a plurality of the first high-resolution pictures, using a plurality of the estimated motion vectors, and the coding further includes selecting one of the plurality of the high-resolution pictures generated in the up-converting, in order to be used as the actual reference picture of the to-be-coded picture.

Moreover, the picture decoding method according to the present invention decodes a bitstream in which each moving picture is coded as a high-resolution picture or a low-resolution picture. The picture decoding method includes: decoding a to-be-decoded picture coded in the bitstream; up-converting resolution of a low-resolution decoded picture to generate a high-resolution picture, when the decoded picture has been coded as a low-resolution picture; and outputting the high-resolution picture whose resolution is up-converting in the up-converting.

Further, the up-converting may include: estimating a motion vector, per one or more pixels, for a first low-resolution picture from a second low-resolution picture, the first low-resolution picture being decoded in the decoding, and the second low-resolution being decoded in the decoding and having been used as a reference picture in coding of the first low-resolution picture; obtaining, based on the estimated motion vector, a pixel value of a pixel in a second high-resolution picture which corresponds to the pixel used in the estimating, the second high-resolution picture representing the same image of the second low-resolution picture but having different resolution; and generating a first high-resolution picture using the obtained pixel value, in order to be outputted as the high-resolution picture in the outputting, the first high-resolution picture representing the same image of the first low-resolution picture but having different resolution.

Note that the present invention can be realized not only as the above-described picture coding method and picture decoding method, but also as a device which includes characteristic processing performed by the methods, and as a program which causes a computer to perform the processing. Here, it is obvious that such a program can be distributed via a memory medium such as a CD-ROM, or a transmission medium such as the Internet.

As described above, according to the picture coding method of the present invention, when pictures in the same stream are coded, resolution of each picture is switched, depending on a picture type, between high-resolution and low-resolution. As a result, it is possible to significantly reduce a coding amount, as compared to coding of the pictures as all high-resolution pictures. Furthermore, according to the picture decoding device of the present invention, a picture processing unit estimates a motion vector per pixel using a low-resolution reference picture. Then, using the estimated motion vector, a pixel value is extracted from a pixel at a corresponding position in a high-resolution picture which is the same picture of the low-resolution reference picture but has different resolution. The extracted pixel value is used to generate a target high-resolution picture. As a result, motion pictures can be reproduced as all high-resolution pictures. Accordingly, by the picture coding method and the picture decoding method of the present invention, input pictures can be coded efficiently, which is highly suitable for practical use.

### FURTHER INFORMATION ABOUT TECHNICAL BACKGROUND TO THIS APPLICATION

The disclosure of Japanese Patent Application No. 2005-2828511 filed on Sep. 8, 2005 including specification, drawings and claims is incorporated herein by reference in its entirety.

### BRIEF DESCRIPTION OF THE DRAWINGS

These and other objects, advantages and features of the present invention will become apparent from the following description thereof taken in conjunction with the accompanying drawings that illustrate specific embodiments of the present invention. In the Drawings:

FIG. 1 is a block diagram showing a structure of a picture processing unit 100 according to the present invention;

FIG. 2 is a diagram showing a relationship between a low-resolution picture and a high-resolution picture;

FIG. 3A is a diagram showing a method of estimating a motion vector per pixel between low-resolution pictures;

FIG. 3B is a diagram showing a method of motion estimation among low-resolution pictures CL and RL, and high-resolution pictures RH and MH;

FIG. 4 is a diagram showing a method of generating the high-resolution (motion-compensated) picture MH referring to the high-resolution picture RH, based on a motion vector MV provided from a motion estimation unit 102;

FIG. 5 is a block diagram showing a structure of a picture processing unit 800 which is a variation of the first embodiment;

FIG. 6 is a diagram showing an example of motion estimation referring to combinations of a plurality of reference pictures;

FIG. 7 is a block diagram showing a structure of a picture coding device which generates a motion-compensated picture regarding a to-be-coded high-resolution picture, using a picture processing unit 100 (or 800) described in the first embodiment, according to the second embodiment;

FIG. 8 is a diagram showing a description example of flag information indicating which picture processing method has been used by the picture processing unit 100 (or 800);

FIG. 9 is a block diagram showing a structure of a picture decoding device according to the third embodiment;

FIG. 10 is a block diagram showing a structure of a picture coding device 900 according to the fourth embodiment;

FIG. 11 shows (a) a diagram showing input moving pictures which are high-resolution pictures, (b) a diagram showing an example of resolution conversion, where I-pictures and P-pictures are coded as high-resolution pictures, and (c) a diagram showing another example of resolution conversion, where only I-pictures are coded as high-resolution pictures;

FIG. 12 is a block diagram showing a structure of a picture coding device 1000 according to a variation of the fourth embodiment;

FIG. 13 is a block diagram showing a structure of a picture decoding device which converts a decoded low-resolution picture into a high-resolution picture to be outputted, in post-processing of decoding;

FIG. 14 is a block diagram showing a structure of a picture decoding device according to a variation of the fifth embodiment;

FIGS. 15A, 15B and 15C show explanatory diagrams of a recording medium which stores a program causing a computer system to execute the picture processing method, the picture coding method, and the picture decoding method according to the embodiments;

FIG. 16 is a block diagram showing an overall structure of a content supplying system;

FIG. 17 is a diagram showing a portable telephone which uses the picture processing method, the picture encoding method, and the picture decoding method;

FIG. 18 is a block diagram of the portable telephone; and

FIG. 19 is a diagram showing an example of a digital broadcasting system.

### DESCRIPTION OF THE PREFERRED EMBODIMENT(S)

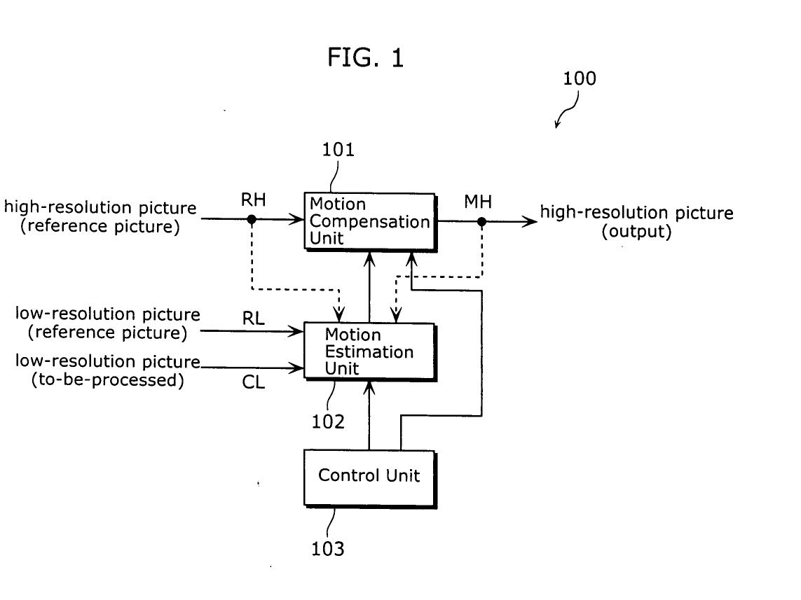

The following describes the embodiments according to the prevent invention with reference to FIGS. 1 to 19.

### First Embodiment

FIG. 1 is a block diagram showing a structure of a picture processing unit 100 according to the present invention. The picture processing unit 100 of the first embodiment is a processing unit which generates a motion-compensated picture of an input picture, using (i) motion vectors estimated between a low-resolution picture, which is generated by reducing resolution (hereinafter, expressed also as “down-converting resolution”) of the high-resolution input picture, and a low-resolution reference picture, and (ii) another high-resolution picture which is the same picture of the low-resolution reference picture but has the different resolution. The picture processing unit 100 includes a motion compensation unit 101, a motion estimation unit 102, and a control unit 103.

The motion estimation unit 102 is provided with a low-resolution picture RL as a reference picture, and a low-resolution picture CL which is obtained by down-converting resolution of the input high-resolution picture to be coded. The motion compensation unit 101 is provided with a high-resolution picture RH as a reference picture.

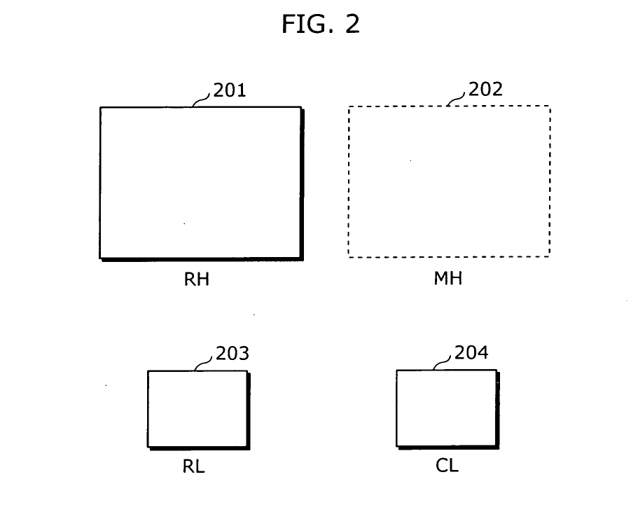

FIG. 2 is a diagram showing a relationship between a low-resolution picture and a high-resolution picture. The low-resolution picture RL and the high-resolution picture RH are generated from the same picture, in other words, the low-resolution picture RL and the high-resolution picture represent the same image but having different resolution. Examples of the relationship between the low-resolution picture RL and the high-resolution picture RH are: the low-resolution picture RL is a picture generated by down-converting resolution of the high-resolution picture RH; the low-resolution picture RL and the high-resolution picture RH are a pair of pictures generated by applying respective hierarchical picture coding to the same picture; the low-resolution picture RL and the high-resolution picture RH are pictures generated by down-converting resolution of the same picture at different down-conversion ratios respectively; and the like. In FIG. 2, a resolution ratio of a low-resolution picture to a high-resolution picture is 1:2 horizontally and vertically, but the resolution ratio is not limited to the above value.

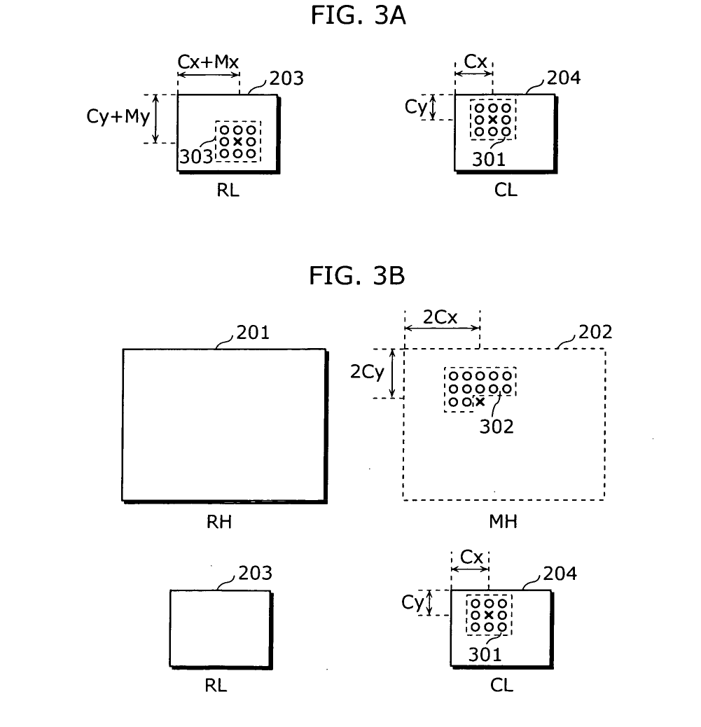

Referring back to FIG. 1, the motion estimation unit 102 estimates motion of the low-resolution picture CL referring to the low-resolution picture RL. For the motion estimation, the control unit 103 designates a position of a block for which the motion estimation is performed, a range to be searched, a size of the block, and the like. FIG. 3A is a diagram showing a method of estimating a motion vector per pixel between low-resolution pictures. The motion estimation method is described below with reference to FIG. 3A. In this example, it is assumed that the control unit 103 designates (Cx, Cy) as a position of the block in the low-resolution picture CL for the motion estimation, and 1×1 pixel as a size of the block. That is, a motion vector is estimated for a pixel located at the position (Cx, Cy) in the low-resolution picture CL, from the low-resolution picture RL. In FIGS. 3A and 3B, the pixel is represented by a symbol x, and the number of pixels in the block is 1. Hereinafter, this pixel is referred to as a target pixel. For the motion estimation of the target pixel, surrounding pixels positioned around the target pixel may be also used. For example, regarding a 3×3-pixel region 301 including the target pixel in the low-resolution picture CL, a corresponding region is searched in the low-resolution reference picture RL in order to perform motion estimation. Note that a size of the region for the motion estimation may have different number of pixels. Note also that the motion estimation may be performed without the surrounding pixels for the search, if a target for the motion estimation has a plurality of pixels. In the motion estimation, a cost function is set to be used to specify a corresponding position in the low-resolution reference picture RL, where the cost function becomes a minimum value. Note that the cost function may be a difference value (a difference absolute sum or a difference square sum) between (i) pixel values in the region 301 in the low-resolution picture CL and (ii) pixel values in the region in the low-resolution reference picture RL, having the same size as the region 301. Further, the cost function may be obtained by adding the difference value with another value, such as a value obtained by multiplying, by a weighting factor, a degree of difference between the detected motion vector and motion vectors from surrounding pixels or the surrounding blocks. Note also that a difference value between the target pixel and the corresponding pixel in the reference picture may be calculated using pixel values in the pictures directly, or using values obtained by applying a windowing function, such as Hanning Window, to the pixel values. If a region 303 in the low-resolution picture RL is a position where such a cost function becomes minimum, an estimated motion amount is (Mx, My).

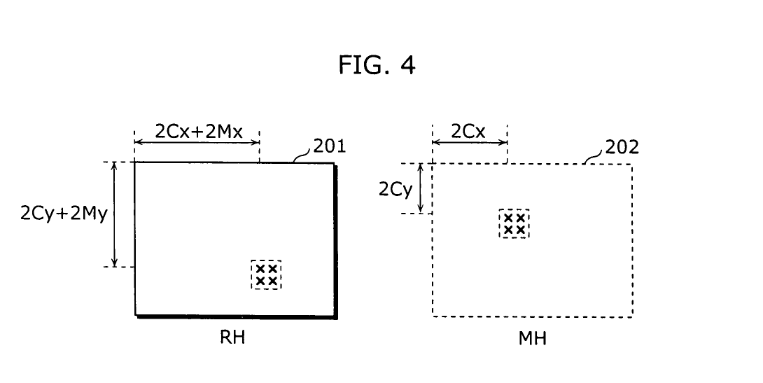

Referring back to FIG. 1, the motion amount estimated by the motion estimation unit 102 is provided as a motion vector MV to the motion compensation unit 101. The motion compensation unit 101 receives the high-resolution picture RH and the above-described motion vector MV. The motion compensation unit 101 generates a high-resolution motion-compensated picture MH from the high-resolution picture RH, based on the position information provided from the control unit 103 and the motion vector MV provided from the motion estimation unit 102. FIG. 4 is a diagram showing a method of the generating of the high-resolution motion-compensated picture MH from the high-resolution picture RH, based on the motion vector MV provided from the motion estimation unit 102. The method is described below with reference to FIG. 4. As shown in FIG. 2, the resolution ratio of the low-resolution picture to the high-resolution picture is 1:2 vertically and horizontally, so that pixels in the high-resolution picture MH which is equivalent to the target pixel positioned at (Cx, Cy) in the low-resolution picture CL are specified as a 2×2-pixel region including a position (2Cx, 2Cy) at the upper left in the region. The motion vector between the high-resolution pictures becomes 2MV, by respectively doubling components in a horizontal direction and in a vertical direction. Therefore, pixels in the high-resolution picture RH which correspond to the target pixels in the high-resolution picture MH are specified as a 2×2-pixel region including a position (2Cx+2Mx, 2Cy+2My) at the upper left in the region.

Subsequently, the above processing is repeated for all regions in the low-resolution picture CL, and the motion compensation is performed for all equivalent regions in the high-resolution picture MH referring to the high-resolution picture RH, to generate the high-resolution motion-compensated picture MH. Thereby, it is possible to generate the high-resolution picture MH using pixel values of high-frequency components, which are not included in the low-resolution picture RL, but included in the high-resolution picture RH. Thus, it is possible to generate the high-resolution picture MH whose resolution is as high as the resolution of the high-resolution picture RH. This means that such a high-resolution motion-compensated picture MH is not realized by using pixel values in a picture generated by merely increasing resolution (hereinafter, expressed also as “up-converting resolution”) of the low-resolution picture RL using pixel compensation.

Note that the first embodiment has been described that the motion estimation unit 102 performs motion estimation between the low-resolution picture CL and the low-resolution picture RL, but the motion estimation may be performed after up-converting resolution of the low-resolution pictures RL and CL twice respectively, to be obtain a motion vector. In the above case, in order to generate the high-resolution picture MH, motion compensation can be performed per pixel, referring to the high-resolution picture RH.

Note also that the first embodiment has been described that the motion estimation unit 102 performs the motion estimation per one pixel precision, between the low-resolution picture CL and the low-resolution picture RL, but it is also possible that, after up-converting resolution of the low-resolution picture RL, the motion estimation is performed to obtain a motion vector per ¼ pixel precision or ⅛ pixel precision. Using such processing, in order to generate the high-resolution motion-compensated picture MH, motion compensation can be performed referring to the high-resolution picture RH by decimal pixel precision. In this case, motion compensation is performed after resolution up-converting (interpolation) of the high-resolution picture RH.

Note also that the first embodiment has been described that one same reference picture is used for the motion estimation and the motion compensation, but it is possible to use a plurality of reference pictures.

Note also that the first embodiment has been described that the motion estimation unit 102 performs motion estimation between the low-resolution picture CL and the low-resolution picture RL, but the motion estimation may be performed between the high-resolution picture RH and the high-resolution picture MH. FIG. 3B is a diagram showing a method of motion estimation among the low-resolution pictures CL and RL and the high-resolution pictures RH and MH. The method is described below with reference to FIG. 3B. In this example, all of pixels in the high-resolution picture MH have not yet been generated. Therefore, motion estimation is performed for a pixel in the region 301 in the low-resolution picture CL from the low-resolution picture RL, and for a pixel in a region 302 in the high-resolution region MH from the high-resolution picture RH. More specifically, a difference value between pixel values in a cost function which is considered in motion estimation includes: a difference value between the pixel values in the region 302 in the high-resolution picture MH and pixel values in a region in the high-resolution picture RH (having the same size as the region 301); in addition to a difference value between the pixel values of the region 301 in the low-resolution picture CL and pixel values in a region in the low-resolution picture RL (having the same size as the region 301). In this case, a motion vector resulting in a minimum cost function is set to a motion vector of the pixel represented by the symbol x.

Note also that the high-resolution picture RH, which is used as a reference picture, is not limited to the previously obtained high-resolution picture, but may be a high-resolution picture generated during the processing described in the first embodiment.

### Variation of First Embodiment

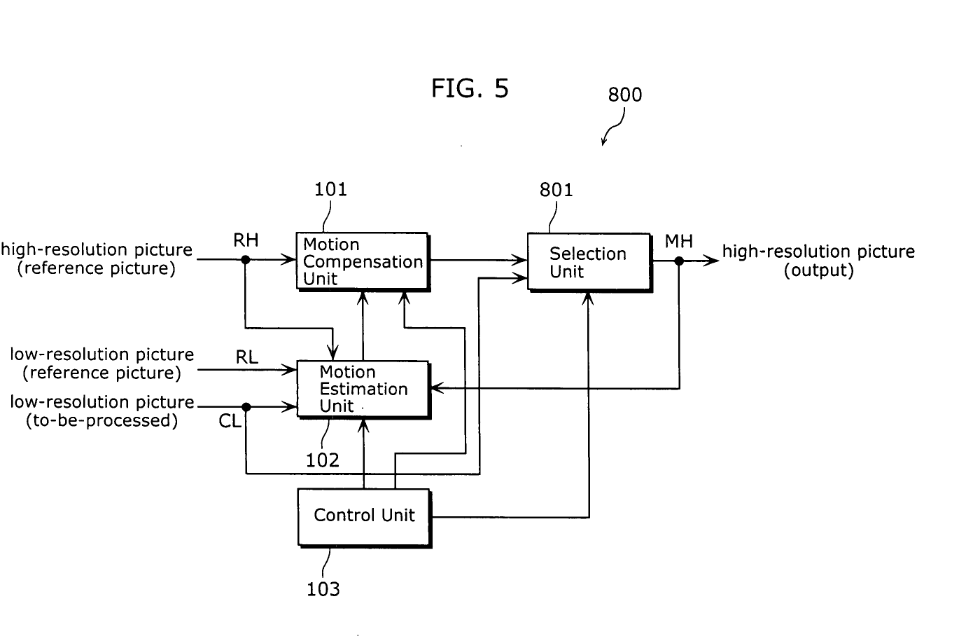

Another picture processing unit 800, which is a variation of the picture processing unit 100 according to the first embodiment, is described with reference to FIG. 5. FIG. 5 is a block diagram showing a structure of the picture processing unit 800 according to the variation of the first embodiment. The picture processing unit 800 of the variation of the first embodiment basically has the same structure of the picture processing device 100 of the present invention described referring to FIG. 1, but further includes a selection unit 801. In the first embodiment, in the circumstances where the low-resolution picture CL regarding the target high-resolution motion-compensated picture MH has been already obtained, a motion vector is estimated between the low-resolution picture CL and the low-resolution reference picture RL (or motion vectors are estimated between the low-resolution picture CL and the low-resolution picture RL, and between the high-resolution picture MH and the high-resolution picture RH), and based on the estimated motion vector, the high-resolution motion-compensated picture MH is generated from the high-resolution picture RH by motion compensation. On the other hand, this variation is characterized in that the motion vector is estimated by various methods, then various motion-compensated pictures are generated using the estimated various motion vectors, and eventually an optimal motion-compensated picture is selected from the various motion-compensated pictures.

Here, the motion estimation unit 102 and the motion compensation unit 101 correspond to a unit which performs “estimating a plurality of motion vectors, regarding already-generated pixels, for the first low-resolution picture from a plurality of the second low-resolution pictures, and for the first high-resolution picture from a plurality of the second high-resolution pictures”, and the selection unit 801 corresponds to a unit which performs “generates a plurality of the first high-resolution pictures, using a plurality of the estimated motion vectors”, in the one of claims appended to this specification.

The motion estimation unit 102 is provided with: the low-resolution picture RL which is a reference picture; the low-resolution picture CL which is a picture to be coded; the high-resolution picture RH which is a reference picture; and the high-resolution motion-compensated picture MH which is a picture to be processed and has been partly generated. The motion compensation unit 101 is provided with the high-resolution picture RH. Here, each of the reference pictures, which are the low-resolution picture RL and the high-resolution picture RH, may be comprised of a plurality of pictures.

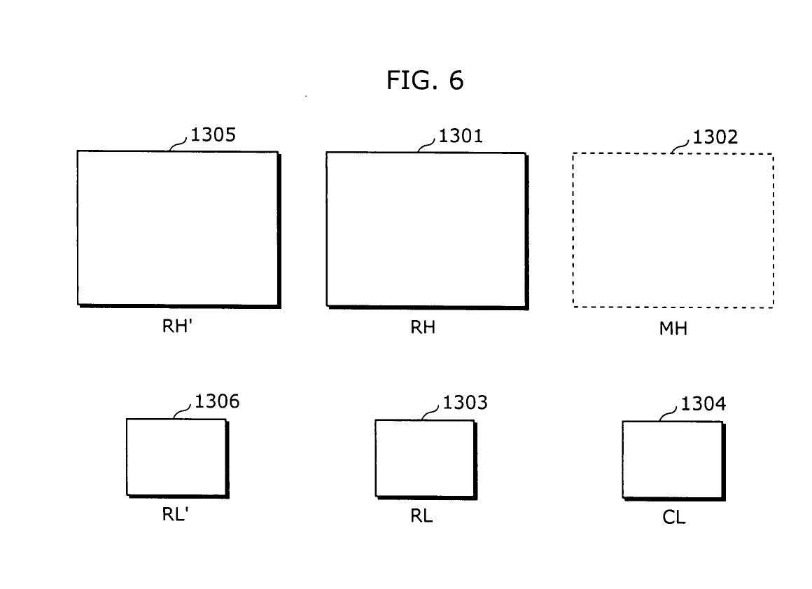

The motion estimation unit 102 performs motion estimation using different combinations of pictures. FIG. 6 is a diagram showing an example of the motion estimation using combinations of plural reference pictures. When there are two kinds of reference pictures (each has two different resolution pictures) as shown in FIG. 6, examples of the combinations are as the followings.

A. low-resolution picture CL (1304)←low-resolution picture RL (1303)

B. low-resolution picture CL (1304) and high--resolution picture MH (1302)←low-resolution picture RL (1303) and high-resolution picture RH (1301)

C. low-resolution picture CL (1304) and high-resolution picture MH (1302)←low-resolution picture RL (1306) and high-resolution picture RH (1305)

D. high-resolution picture MH (1302)←high-resolution picture RH (1301)

E. high-resolution picture MH (1302)←high-resolution picture RH (1305)

F. low-resolution picture CL (1304) and high-resolution picture MH (1302)←low-resolution picture RL (1303), high-resolution picture RH (1301), low-resolution picture RL (1306), and high-resolution picture RH (1305)

G. high-resolution picture MH (1302)←high-resolution picture RH (1301) and high-resolution picture RH (1305)

H. low-resolution picture CL (1304)←low-resolution picture RL (1306)

I. low-resolution picture CL (1304)←low-resolution picture RL (1303) and low-resolution picture RL (1306)

Note that “X←Y” means that motion of a picture X is estimated using a reference picture Y. Note also that, in F, G, and I, motion is estimated using two kinds of reference pictures (each has two different resolution pictures), and an average picture (weighted average) of motion-compensated pictures generated by using the respective reference pictures is set to an optimal motion-compensated picture. Here, the average picture is generated by calculating an average of pixel values of pixels located at the same position in the two motion-compensated pictures, and then generating a motion-compensated picture which has the calculated average pixel value in a pixel located at the same position as the pixels of the motion-compensated pictures. The weighted average means calculation by which the pixel values of the two motion-compensated pictures are multiplied by a weighting factor respectively, and the multiplied values are added together and then divided by a value of two. The method of the motion estimation is the same as described in the first embodiment, so that the method is not described again below.

Referring again to FIG. 5, the respective motion amounts estimated by the respective methods (combinations) are provided as motion vectors MV to the motion compensation unit 101. The motion compensation unit 101 generates a plurality of motion-compensated pictures using the respective motion vectors obtained from the motion estimation unit 102, and provides the resulting motion-compensated pictures to the selection unit 801. The method of generating motion-compensated pictures using motion vectors MV is the same as described in the first embodiment, so that the method is not described again below.

The selection unit 801 is provided with the low-resolution picture CL and a plurality of the motion-compensated pictures generated by the motion compensation unit 101. The selection unit 801 selects an optimal motion-compensated picture among the plurality of motion-compensated pictures. Here, as one example of criteria of the selection, resolution of the motion-compensated pictures are down-converted to be the same as resolution of the low-resolution picture CL, and a certain picture is selected from the down-converted-resolution pictures, so that a difference value (difference absolute sum or difference square sum) between the selected down-converted-resolution picture and the low-resolution picture CL becomes minimum. Another example is that the motion-compensated pictures and the low-resolution picture CL are applied with frequency conversion, and a certain picture is selected from the down-converted-resolution pictures, so that a difference value (difference absolute sum or difference square sum) of the low-frequency components between the selected converted picture and the converted low-resolution picture CL becomes minimum. Note that, when the difference value is not smaller than a predetermined threshold value, it is possible to select a picture which is obtained by up-converting the low-resolution picture CL to have the same size of the motion-compensated picture. Note also that, when the motion-compensated picture is selected, the selection may be performed per block or region which is a square or rectangle, such as a 4×4-pixel block or an 8×8-pixel block or macroblock, or may be performed per a whole picture.

The selected motion-compensated picture (or image obtained by up-converting the low-resolution picture CL to have the same size of the motion-compensated picture) is outputted as a motion-compensated picture (image) MH.

Note also that the variation of the first embodiment has described that the motion amounts are estimated by the nine methods (combinations), and the motion-compensated pictures are generated according to the respective motion amounts. However, the motion amounts may be estimated by other methods, or by a part of the above-mentioned nine methods.

As described above, by the picture processing method according to the present invention, in the circumstances where the first low-resolution picture, which has been generated from the picture for which the first high-resolution motion-compensated picture MH is to be generated, has been already obtained, motion vectors are estimated for the first low-resolution picture from one or more reference pictures which are the second low-resolution pictures (or motion vectors are estimated between the first low-resolution picture and the second low-resolution pictures, and between the first high-resolution picture and the second high-resolution pictures), and based on the estimated motion vectors, the first high-resolution picture is generated from the second high-resolution picture by motion compensation.

The above-described processing is applied to a small data unit, such as one pixel, thereby generating the first high-resolution picture having high image quality. Further, this processing uses results of motion estimation between the low-resolution pictures or results of motion estimation between the high-resolution pictures having already generated region. Therefore, this processing does not need the additional information which has been necessary for the conventional processing.

### Second Embodiment

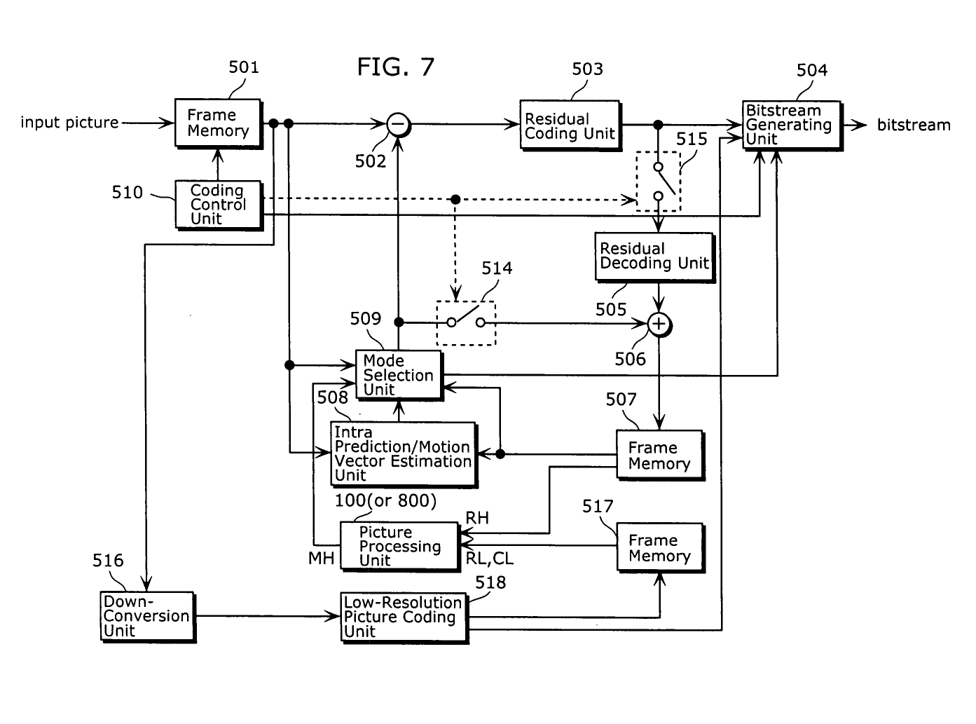

The picture coding device according to the present invention is described with reference to FIG. 7. FIG. 7 is a block diagram showing a structure of a picture coding device which codes a target high-resolution picture into both of a low-resolution picture and a high-resolution picture (hereinafter, referred to also as a “to-be-coded picture”, or a “to-be-coded image”), adaptively using a motion-compensated picture (hereinafter, referred to also as a “motion-compensated image”) generated by the picture processing unit 100 (or 800) described in the first embodiment. As shown in FIG. 7, the picture coding device of the second embodiment includes a frame memory 501, a difference operation unit 502, a residual coding unit 503, a bitstream generating unit 504, a residual decoding unit 505, an addition operation unit 506, a frame memory 507, an intra prediction/motion vector estimation unit 508, a mode selection unit 509, a coding control unit 510, switches 514 and 515, a down-conversion unit 516, a frame memory 517, a low-resolution picture coding unit 518, and a picture processing unit 100 (or 800). The picture processing unit 100 (or 800) has the same structure of the picture processing device 100 of FIG. 1 in the first embodiment or the picture processing device 800 of FIG. 5 described in the variation of the first embodiment.

Input pictures are inputted into the frame memory 501 one by one in order of time. The pictures inputted into the frame memory 501 are sorted in a coding order, under the control of the coding control unit 510. This coding order sorting is performed depending on reference relationships between pictures in inter-picture prediction coding. In other words, the pictures are sorted in the order, so that a picture referred by another picture is positioned prior to the picture.

The pictures sorted in the frame memory 501 are sequentially coded. Each of the pictures is firstly passed to the down-conversion unit 516. The down-conversion unit 516 converts a given picture into a low-resolution picture, by down-converting resolution of the given picture, for example, at a down-conversion ratio of 1:2 horizontally and vertically. The resulting low-resolution picture is coded on a block-by-block basis, by the low-resolution picture coding unit 518. It is assumed that the low-resolution picture coding unit 518 codes the low-resolution picture (hereinafter, referred to also as a “low-resolution image”) according to a JPEG standard or a MPEG standard. The low-resolution picture coding unit 518 generates a bitstream which includes: a motion vector obtained by motion estimation of the low-resolution image; and a prediction residual between the low-resolution image and a motion-compensated image obtained by the motion vector. The bitstream generated by the low-resolution picture coding unit 518 is provided to the bitstream generating unit 504. Further, the low-resolution picture coding unit 518 generates a partly-decoded image. The partly-decoded image is an image obtained by coding the target low-resolution image and then decoding the coded image. The partly-decoded image is stored in the frame memory 517.

Moreover, the pictures sorted in the frame memory 501 are also coded to be high-resolution pictures. In this processing, each of the pictures is assumed to be read out from the frame memory 501 on a macroblock-by-macroblock basis. Here, a size of one macroblock is assumed to be 16×16 pixels. Moreover, the macroblock is applied with motion compensation on a block-by-block basis. Here, a size of one block is assumed to be 8×8 pixels. In the following, the coding processing is described step by step, assuming that a to-be-coded picture is a uni-directional prediction coded picture, in other words, a predictive coded picture (P-picture).

The coding control unit 510 decides which picture type (I, P, or B picture) the input picture to be coded to. Then the coding control unit 510 controls the switches 514 and 515 according to the decided picture type. Here, the decision of picture types is generally performed by allocating picture types periodically to the input pictures. According to the decision of picture types, the pictures are stored in a coding order in the frame memory 501.

In order to code a P-picture, the coding control unit 510 controls the switches 514 and 515 to be turned ON. Thereby, each macroblock included in the to-be-coded picture is read out from the frame memory 501, and passed firstly to the intra prediction/motion vector estimation unit 508, then the mode selection unit 509, and then the difference operation unit 502.

The intra prediction/motion vector estimation unit 508 performs decision of an intra prediction method or estimation of a motion vector, for each block in the macroblock, using a decoded image data accumulated in the frame memory 507, as a reference picture (hereinafter, referred to also as a “reference image”). Here, the intra prediction is a method for generating a predictive picture (hereinafter, referred to also as a “predictive image”) using pixels surrounding a to-be-coded block. The decided intra prediction method or the motion vector, and a intra-picture predictive image generated by the intra prediction or a motion-compensated image generated by the motion vector are outputted to the mode selection unit 509.

The picture processing unit 100 (800) is provided: from the frame memory 517, with a low-resolution image RL as a reference image, and a low-resolution image CL which has been generated from the to-be-coded picture as described above; and from the frame memory 507, with a high-resolution picture RH (hereinafter, referred to also as a “high-resolution image RH” or “high-resolution reference image RH”) as a reference picture, which has been generated from the same picture of the low-resolution image RL. Then, the picture processing unit 100 (or 800) generates a motion-compensated image MH in the same manner as described in the first embodiment of the present invention and in the variation of the first embodiment, and passes the resulting image MH to the mode selection unit 509.

The mode selection unit 509 decides a coding mode for each macroblock, based on: the intra prediction method or the estimated motion vector, and the obtained intra-picture predictive image or the motion-compensated image, which are provided from the intra prediction/motion vector estimation unit 508; and the motion-compensated image MH generated by the picture processing unit 100 (800). Here, the coding mode indicates what kind of method is used to code each macroblock. For example, in this case of the P-picture, a method to be used is assumed to be selected from: intra prediction coding; inter-picture prediction coding using a motion-compensated image which has been generated using the motion vector estimated by the motion estimation unit 508; and inter-picture prediction coding using a motion-compensated image which has been generated by the picture processing unit 100 (800). For the general decision of coding mode, a coding mode is decided so that a bit amount and a coding error are reduced more. When the macroblock is coded by the inter-picture prediction coding using a motion-compensated image which has been generated using the motion vector estimated by the motion estimation unit 508, the above-mentioned bitstream needs to describe a code of the motion vector, in addition to a code of motion compensation residual. Here, the motion-compensated image is generated using a motion vector which is obtained per data unit of 8×8 pixels. On the other hands, when the macroblock is coded by another inter-picture prediction coding using a motion-compensated image which has been generated by the picture processing unit 100 (800), a bitstream describes only a code of motion compensation residual. The motion-compensated image provided from the picture processing unit 100 (800) has been generated using a motion amount per minimum one pixel, referring to the low-resolution image. Here, an attention should be paid to that the low-resolution picture coding unit 518 always codes an input picture as a low-resolution picture and generates a bitstream. However, the picture coding device according to the second embodiment codes the same input picture also as a high-resolution picture. In the coding of the high-resolution picture (image), the mode selection unit 509 selects a coding method whose coding efficiency is the highest, and generates another bitstream.

The coding mode decided by the mode selection unit 509 is passed to the bitstream generating unit 504. Further, the motion vector is also passed from the mode selection unit 509 to the bitstream generating unit 504.

Next, a reference image selected based on the coding mode decided by the mode decision unit 509 is provided to the difference operation unit 502 and the addition operation unit 506.

The following describes a situation where the mode selection unit 509 selects inter-picture prediction coding.

The difference operation unit 502 is provided, from the mode selection unit 509, with a reference image as well as image data of the to-be-coded macroblock. The difference operation unit 502 calculates a difference between the reference image and the image data of the macroblock, and eventually generates a residual image (hereinafter, referred to also as a “residual picture”) to be outputted.

The residual image is provided to the residual coding unit 503. The residual coding unit 503 applies coding processing, such as frequency conversion and quantization, to the provided residual image, and eventually generates coded data to be outputted. Here, the processing of the frequency conversion and the quantization can be performed, for example, per data unit of 8×8 pixels. The coded data outputted from the residual coding unit 503 is passed to the bitstream generating unit 504 and the residual decoding unit 505.

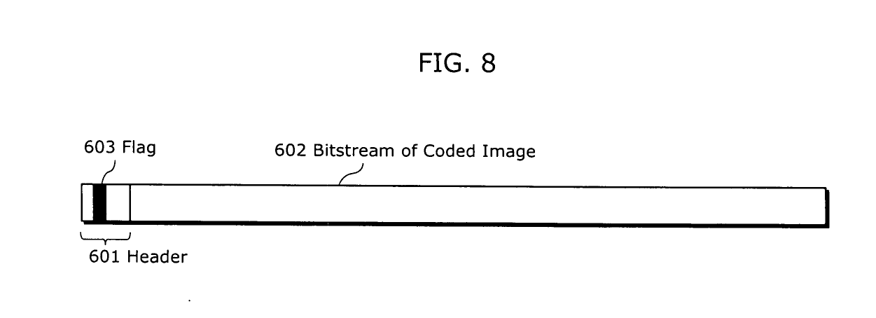

The bitstream generating unit 504 applies variable length coding and the like to the provided coded data, and generates a bitstream by adding the resulting data with various information. Examples of the various information are: information of the motion vector (motion vector information) and information of the coding mode (coding mode information) which are provided from the mode selection unit 509 (more specifically, information indicating that coding is performed by (1) intra prediction coding, (2) inter-picture prediction coding, or (3) inter-picture coding, by which a high-resolution image of the to-be-coded image is coded using a low-resolution image generated from the same to-be-coded image, according to the present invention; other header information; the bitstream provided from the low-resolution picture generating unit 518; and the like. At the same time, the bitstream may describe, as header information, flag information indicating which processing methods have been used by the picture processing unit 100 (800). More specifically, this flag information indicates: which method has been used for the motion estimation by the picture processing unit 100 (800); which methods have been used to generate motion-compensated images; which motion-compensated image has been selected from the generated motion-compensated images; which criteria has been used in the selection of the motion-compensated image; and which range has been used in searching in the reference high-resolution image RH; and the like. FIG. 8 is a diagram showing an example of description of the flag information indicating which picture processing methods have been used in the picture processing unit 100 (or 800). An example of description positions in the flag information is described with reference to FIG. 8.

Referring back to FIG. 7, the residual decoding unit 505 applies decoding processing, such as inverse-quantization and inverse-frequency transformation, to the provided coded data, and eventually generates a decoded differential image to be outputted. The addition operation unit 506 adds the decoded differential image with a predictive image thereby generating a decoded image, and then accumulates the decoded image into the frame memory 507.

The other remaining macroblocks included in the to-be-coded picture are coded as high-resolution images, in the same manner as described above.

As described above, in the picture coding method of the present invention, a high-resolution image is coded at a coding mode in which a motion-compensated image is generated using a motion vector obtained from a low-resolution image generated from the same input image of the high-resolution image. In the conventional coding mode in which a motion-compensated image is generated using a motion vector obtained between the high-resolution image and a high-resolution reference image, it is necessary to describe information of the motion vector in the bitstream. Furthermore, in order to improve motion compensation precision at the conventional coding mode, it is necessary to increase the number of motion vectors per macroblock, which results in further increase of a coding amount of the motion vector information. At the coding mode according to the present invention, however, it is not necessary to describe such motion vector information in the bitstream. Therefore, it is possible to improve motion compensation precision by increasing the number of motion vectors, and thereby significantly increasing coding efficiency.

### Third Embodiment

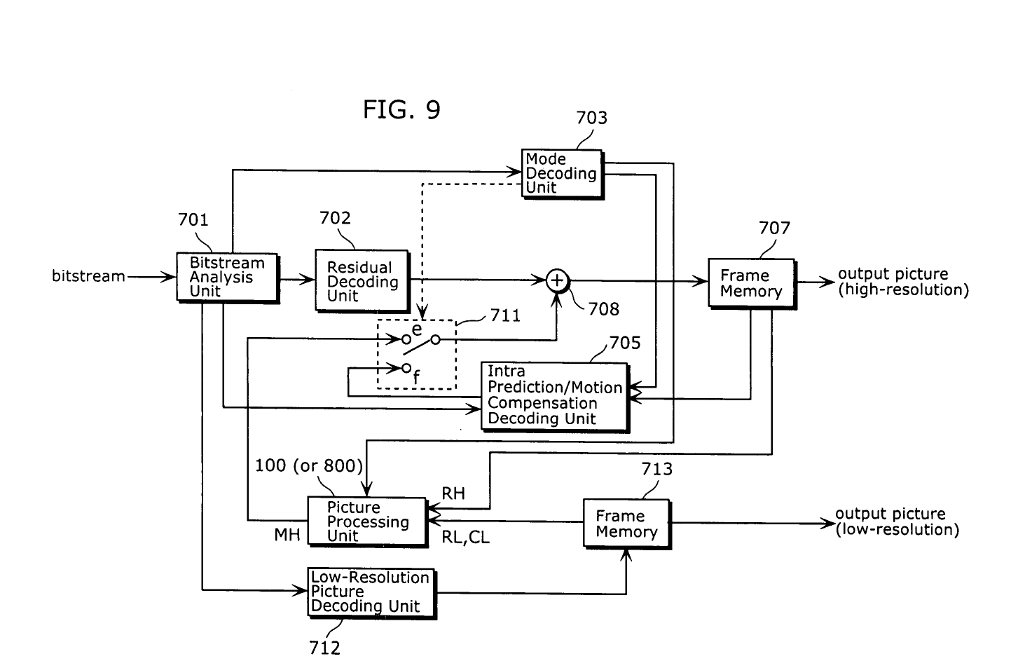

A picture decoding device according to the present invention is described with reference to FIG. 9. FIG. 9 is a block diagram showing a structure of the picture decoding device according to the third embodiment. The picture decoding device according to the third embodiment decodes the bitstream generated by the picture coding device according to the second embodiment. The picture decoding device includes a bitstream analysis unit 701, a residual decoding unit 702, a mode decoding unit 703, an intra prediction/motion compensation decoding unit 705, a frame memory 707, an addition operation unit 708, a switch 711, a low-resolution picture decoding unit 712, a frame memory 713, and a picture processing unit 100 (or 800). An example of processing for decoding a coded P-picture is described in detail below.

The bitstream of the P-picture is inputted to the bitstream analysis unit 701. The bitstream analysis unit 701 separates the input bitstream into a bitstream of the low-resolution image and a bitstream of the high-resolution image. The bitstream of the low-resolution image is passed to the low-resolution picture decoding unit 712, and the low-resolution picture decoding unit 712 decodes the bitstream by a method appropriate for the coding method (JPEG standard or MPEG standard). The decoded low-resolution image is accumulated in the frame memory 713.

Moreover, the bitstream analysis unit 701 extracts various data from another separated bitstream of the high-resolution image. Here, the various data includes the mode selection information, the motion vector information, the header information, and the like. The extracted mode selection information is provided to the mode decoding unit 703. The extracted motion vector information is provided to the intra prediction/motion compensation decoding unit 705. The residual coded data is provided to the residual decoding unit 702. Here, if flag information as the header information is described in the bitstream to indicate which methods have been used in the coding processing by the picture processing unit 100 (800), this flag information is provided to the picture processing unit 100 (800). For instance, this flag information indicates: which method has been used for the motion estimation by the picture processing unit 100 (800); which methods have been used to generate motion-compensated images; which motion-compensated image has been selected from the generated motion-compensated images; which criteria has been used in the selection of the motion-compensated image; and which range has been used in searching in the reference high-resolution image RH; and the like.

The mode decoding unit 703 controls the switch 711 referring to the mode selection information extracted from the bitstream. When the mode selection information indicates that the selected mode is inter-picture prediction coding using the motion vector information described in the bitstream, the switch 711 is controlled to be connected to a terminal f. On the other hand, when the mode selection information indicates that the selected mode is inter-picture prediction coding using the motion vector obtained using the low-resolution image (as described in the first embodiment of the present invention), the switch 711 is controlled to be connected to a terminal e.

Further, when, as mentioned above, the mode selection information indicates that the selected mode is inter-picture prediction coding using the motion vector information described in the bitstream, the mode decoding unit 703 provides the mode selection information to the intra prediction/motion compensation decoding unit 705. On the other hand, when, as mentioned above, the mode selection information indicates that the selected mode is inter-picture prediction coding using the motion vector obtained using the low-resolution image, the mode decoding unit 703 provides the mode selection information to the picture processing unit 100 (800).

The residual decoding unit 702 decodes the input residual coded data, thereby generating a residual image. The generated residual image is provided to the addition operation unit 708.

Furthermore, when, as mentioned above, the mode selection information indicates that the selected mode is inter-picture prediction coding using the motion vector information described in the bitstream, the intra prediction/motion compensation decoding unit 705 performs motion compensation. The intra prediction/motion compensation decoding unit 705 decodes the coded motion vector provided from the bitstream analysis unit 701. Then, using the decoded motion vector, the intra prediction/motion compensation decoding unit 705 generates a motion-compensated image (block) from a reference picture obtained from the frame memory 707. The motion-compensated image generated as described above is provided to the addition operation unit 708.

On the other hand, when, as mentioned above, the mode selection information indicates that the selected mode is inter-picture prediction coding using the motion vector obtained using the low-resolution image, the picture processing unit 100 (800) performs motion compensation. The picture processing unit 100 (800) is provided from the frame memory 713 with a low-resolution image RL as a reference image and a low-resolution image CL generated from the to-be-decoded image, and also from the frame memory 707 with the decoded high-resolution reference image RH generated from the same image of the low-resolution reference image RL. The picture processing unit 100 (800) generates a motion-compensated image MH of the to-be-decoded image, in the same manner described in the first embodiment of the present invention and the variation of the first embodiment. The generated motion-compensated image MH is provided to the addition operation unit 708 through the switch 711.

The addition operation unit 708 adds the provided residual image with the motion-compensated image, thereby generating a decoded image. The generated decoded image is provided to the frame memory 707.

As described above, macroblocks in the P-picture are sequentially decoded. After decoding all macroblocks in the to-be-decoded picture, decoding is performed for a picture to be decoded next.

Thus, in the picture decoding method according to the present invention, a low-resolution picture is retrieved from a bitstream in which both of the low-resolution picture and a high-resolution picture are coded, and decoded. Then, the high-resolution picture is retrieved and decoded, at a coding mode in which a motion-compensated image is generated using a motion vector obtained per pixel from the low-resolution picture. In the conventional coding mode in which a motion-compensated image is generated using a motion vector between the high-resolution picture and a high-resolution reference picture, it is necessary to describe information of the motion vector in the bitstream. Further, in order to improve motion compensation precision at the conventional coding mode, it is necessary to increase the number of motion vectors per macroblock, which results in increase of a coding amount of the motion vector information. At the coding mode according to the present invention, both of the picture coding device and the picture decoding device employ the same method to estimate motion vectors using the low-resolution picture. Therefore, it is not necessary at all to describe the motion vector information in the bitstream. Thereby, even if the number of motion vectors per macroblock is increased, a coding amount is not increased. Further, by estimating a motion vector per pixel from the low-resolution picture, it is possible to increase the number of motion vectors, and eventually increase precision of motion compensation. As a result, the picture coding device and the picture decoding device according to the present invention can improve precision of motion compensation and obtain high-resolution pictures, without increase of coding amount, so that coding efficiency can be significantly improved.

### Fourth Embodiment

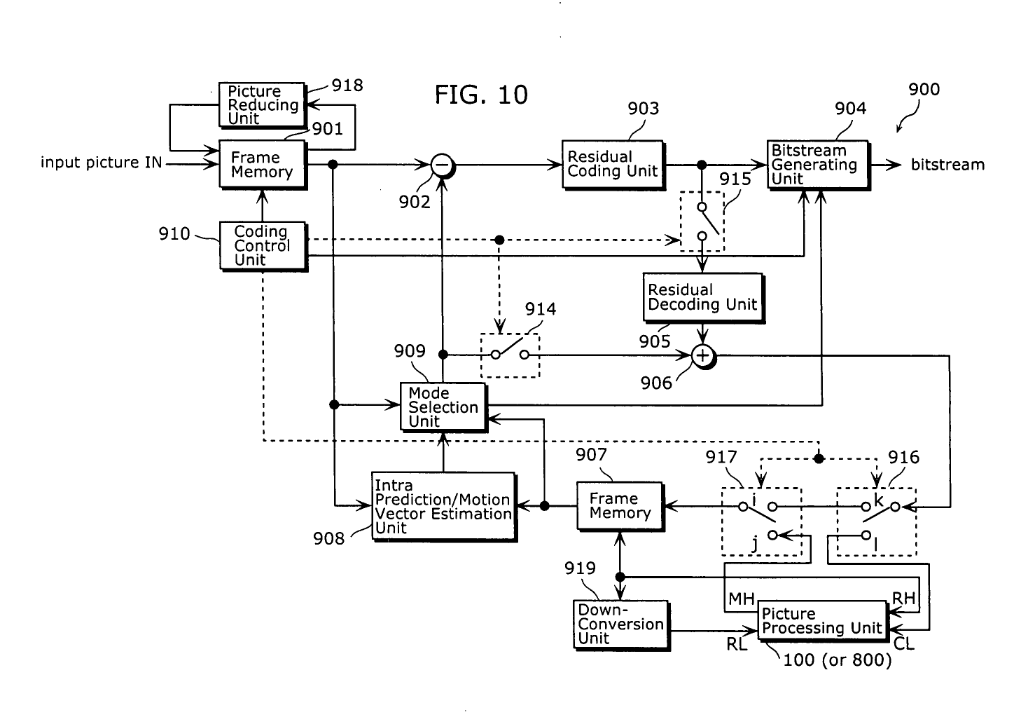

Another picture coding device of the present invention is described with reference to FIG. 10. FIG. 10 is a block diagram showing a structure of a picture coding device 900 according to the fourth embodiment. The picture coding device 900 according to the fourth embodiment codes some input pictures as low-resolution pictures, and other input pictures as high-resolution pictures. When a high-resolution picture is coded referring to a low-resolution coded picture, a high-resolution motion-compensated picture of the low-resolution reference picture is generated by the picture processing unit 100 (or 800) in the same manner as described in the first embodiment. The picture coding device 900 includes a frame memory 901, a difference operation unit 902, a residual coding unit 903, a bitstream generating unit 904, a residual decoding unit 905, an addition operation unit 906, a frame memory 907, an intra prediction/motion vector estimation unit 908, a mode selection unit 909, a coding control unit 910, switches 914 to 917, a down-conversion unit 918, a down-conversion unit 919, and a picture processing unit 100 (or 800). The picture processing unit 100 (or 800) has the same structure of the picture processing device 100 of FIG. 1 described in the first embodiment, or the picture processing device 800 of FIG. 5 described in the variation of the first embodiment.

Here, the coding control unit 910 corresponds to “a coding control unit operable to decide whether or not a to-be-coded picture is to be coded as a high-resolution picture or a low-resolution picture, depending on a picture type of the to-be-coded picture”, the down-conversion unit 917 corresponds to “a first down-conversion unit operable to down-convert resolution of the to-be-coded picture, when the to-be-coded picture is decided to be coded as a low-resolution picture in said coding control unit”, the down-conversion unit 1001 corresponds to “a second down-conversion unit operable to down-convert resolution of a reference picture which has been coded as a high-resolution picture, when the reference picture is referred to by the to-be-coded picture decided to be coded as a low-resolution picture in said coding control unit”, and the motion estimation unit 908, the mode selection unit 909, the difference operation unit 902, and the residual coding unit 903 correspond to “a coding unit operable to code the to-be-coded picture whose resolution is down-converted in said first down-conversion unit, referring to the reference picture whose resolution is down-converted in said second down-conversion unit”, in one of the claims appended to this specification.

Further, the picture processing unit 100 (or 800) corresponds to a unit executing “up-converting resolution of a reference picture which has been coded as a low-resolution picture, when the reference picture is referred to by the to-be-coded picture decided to be coded as a high-resolution picture in said deciding”, and the frame memory 907, the intra prediction/motion estimation unit 908, the mode selection unit 909, the difference operation unit 902, and the residual coding unit 903 correspond to a unit executing “coding, where the to-be-coded picture refers to the reference picture whose resolution is up-converted in said up-converting”, in another claim appended to this specification.

Still further, the picture processing unit 100 (or 800) corresponds to a unit executing “estimating a motion vector, per one or more pixels, for a first low-resolution picture from a second low-resolution picture, the first low-resolution picture being the reference picture of to-be-coded picture and coded as a low-resolution picture, and the second low-resolution picture being a reference picture of the first low-resolution picture in the coding of the first low-resolution picture; obtaining, based on the estimated motion vector, a first pixel value of a pixel in a second high-resolution picture which corresponds to the pixel used in said estimating, the second high-resolution picture representing the same image as the second low-resolution picture but having different resolution; and generating a first high-resolution picture, by using the obtained first pixel value, in order to be used as the actual reference picture of the to-be-coded picture, the first high-resolution picture representing the same image as the first low-resolution picture but having different resolution”, in still another claim appended to this specification.

Still further, the picture processing unit 100 (or 800) corresponds to a unit executing “estimating a motion vector for the first high-resolution picture from the second high-resolution picture, per one or more pixels each of which has been already generated in the first high-resolution picture; obtaining, based on the estimated motion vector, a second pixel value of a pixel in the second high-resolution picture which is positioned at the same location as the pixel in the first high-resolution picture; and generating the first high-resolution picture, by using the an average value of the obtained first and second pixel values in a corresponding pixel, in order to be used as the actual reference picture of the to-be-coded picture”, in another claim appended to this specification.

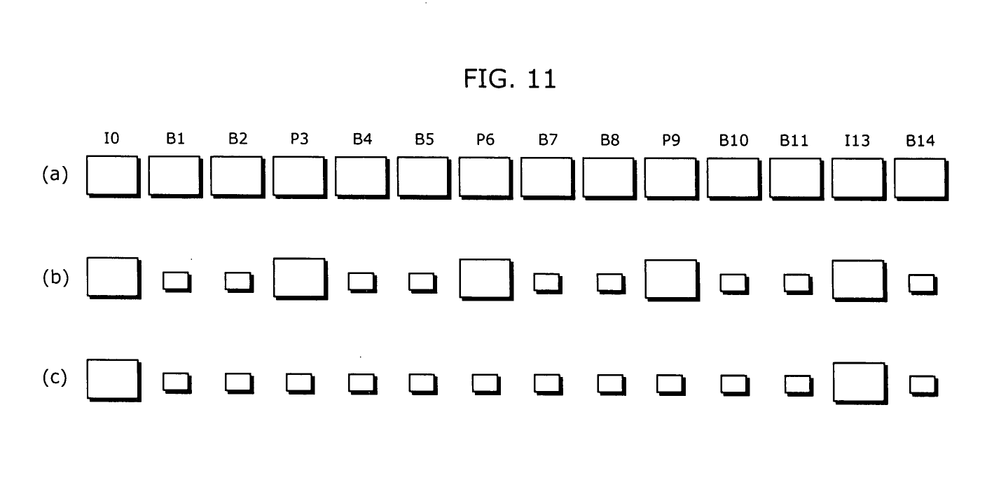

The following explains input pictures in the picture coding device according to the fourth embodiment. FIG. 11(a) is a diagram showing input moving pictures all of which are high-resolution pictures. An example of an input picture sequence is shown in FIG. 11(a). Note that a symbol assigned to each picture represents a picture type (I represents an intra prediction coding picture, P represents an one-directional inter-picture prediction coding picture, and B represents a bi-directional inter-picture prediction coding picture) and a numeral attached to each symbol represents each order in a display order.

The input pictures are inputted into the frame memory 901 one by one in a display order. The pictures inputted into the frame memory 901 are sorted in a coding order. This coding order sorting is performed depending on reference relationships between pictures in inter-picture prediction coding. In other words, the pictures are sorted in the order, so that a picture referred by another picture is positioned prior to the picture. For instance, when a P-picture refers to one immediately-prior I- or P-picture, and a B-picture refers to two I- or P-pictures, one past and one future, the coding order of the pictures becomes, for example, I0, P3, B1, B2, P6, B4, B5 . . . .

Each of the pictures sorted in the frame memory 901 is sequentially coded, but prior to the coding, specific pictures are converted into low-resolution pictures by the down-conversion unit 918. FIG. 11(b) is a diagram showing an example of the resolution conversion, where I-pictures and P-pictures are coded as high-resolution pictures. In this example, as shown in FIG. 11(b), resolution of I- and P-pictures is not converted, but resolution of B-pictures is converted. Another example is that, as shown in FIG. 11(c), resolution of I-pictures is not converted, but resolution of P- and B-pictures is converted. The coding control unit 910 previously stores information indicating which picture type is to be coded as a low-resolution picture, and which picture type is to be coded as a high-resolution picture. According to the stored information, the coding control unit 910 controls to convert each picture as each resolution picture. FIG. 11(c) is a diagram showing another example of the resolution conversion, where only I-pictures are coded as high-resolution pictures. Here, a resolution ratio of a low-resolution picture to a high-resolution picture is shown as 1:2 horizontally and vertically, but the resolution ratio is not limited to the above value. Note that the decision of picture type is assumed to be made by the coding control unit 910.

Note also that each of the to-be-coded high-resolution pictures is assumed to be read out from the frame memory 901 on a macroblock-by-macroblock basis. Here, a size of one macroblock is assumed to be 16×16 pixels.

The following descries a picture coding method performed by the picture coding device according to the present invention, referring to FIG. 10. A macroblock in the to-be-coded high-resolution picture is read out from the frame memory 901. The read-out macroblock is provided firstly to the motion vector estimation unit 908, the mode selection unit 909, and then the difference operation unit 902.

The intra prediction/motion vector estimation unit 908 applies intra prediction or motion vector estimation to each block in the macroblock, referring to a high-resolution decoded image data accumulated in the frame memory 907 as a reference image. The intra prediction method or the estimated motion vector, and the high-resolution motion-compensated image which is generated from the high-resolution reference image obtained by the intra prediction or the motion vector are provided to the mode selection unit 909.

Note that the mode selection unit 909 decides a coding mode for coding each macroblock, using a intra prediction method or a motion vector estimated by the intra prediction/motion vector estimation unit 908, and the obtained high-resolution motion-compensated image. Here, a coding mode indicates what kinds of method are to be used to code a to-be-coded macroblock. For example, it is assumed that I-pictures are to be applied with intra prediction coding. In order to code P- and B-pictures, the method is selected from: intra prediction coding; inter-picture prediction coding using a motion-compensated image which has been generated by the motion vector; and low-resolution coding in which resolution of the to-be-coded image is down-converted. For the general decision of coding mode, a method is decided so that a bit amount and a coding error are reduced more. When the intra prediction coding is applied, a bitstream needs to describe a code indicating the inter-picture prediction coding. When the applied method is the inter-picture prediction coding using a motion-compensated image which has been generated by the motion vector, a bitstream needs to describe a code indicating the motion vector, regardless of whether the to-be-coded image is a low-resolution image or a high-resolution image.

Returning to the description of the coding method, the mode selection unit 909 decides a coding mode for the to-be-coded macroblock in the above-explained manner, and the decided coding mode is passed to the bitstream generating unit 904. The intra prediction method or the motion vector is provided from the mode selection unit 909 to the bitstream generating unit 904. Next, a reference image is selected based on the decided coding mode, and outputted to the difference operation unit 902 and the switch 914.

The difference operation unit 902 obtains, from the mode selection unit 909, the image data of the to-be-coded macroblock together with the reference image. The difference operation unit 902 calculates a difference between the image data of the macroblock and the reference image, thereby generating a residual image to be outputted.

The residual image is provided to the residual coding unit 903. The residual coding unit 903 applies coding processing, such as frequency conversion and quantization, to the provided residual image, and eventually generates coded data to be outputted. Here, the processing of the frequency conversion and the quantization can be performed, for example, per data unit of 8×8 pixels. The coded data outputted from the residual coding unit 903 is passed to the bitstream generating unit 904 and the switch 915.

The bitstream generating unit 904 applies variable length coding and the like to the provided coded data, and adds the resulting data with various information obtained from the mode selection unit 909, such as information of the coding mode, information of the intra prediction method or the motion vector, and other header information, in order to generate a bitstream.

Next, the following describes how a picture data generated during the above-described coding method is used as a reference image for other pictures, referring again to FIG. 10. Here, the coding control unit 910 controls the switches 914 and 915 according to the decided picture type. In order to code I- and P-pictures, which are also used as reference pictures for other pictures, the coding control unit 910 controls the switches 914 and 915 to be turned on. In order to code B-pictures, which are not referred to by any other pictures, the coding control unit 910 controls the switches 914 and 915 to be turned off. The following example is given where a picture type of an input picture is a I- or P-picture.

Here, it is assumed that the residual decoding unit 905 is provided with a coded residual image of the input picture from the residual coding unit 903. The residual decoding unit 905 applies the coded data with decoding processing, such as inverse-quantization and inverse-frequency transformation, and eventually generates a decoded differential image to be outputted to the addition operation unit 906. The addition operation unit 906 adds the decoded differential image with a predictive image, and passes the resulting image to the switch 916.

Here, if resolution of the input picture has been down-converted by the down-conversion unit 918, then the coding control unit 910 connects the switch 916 to a terminal l, and connects the switch 917 to a terminal j. In this case, the data inputted into the switch 916 is processed by the picture processing unit 100 (800) in the same manner as described in the first embodiment of the present invention or the variation of the first embodiment. Thereby, a high-resolution motion-compensated image MH, which is to be used as a reference image for other pictures, is generated by up-converting the picture to have the same resolution as another picture (input picture IN) which refers to the picture. Then, the generated motion-compensated image MH is putted to the switch 917 and then accumulated into the frame memory 907. This generation of the high-resolution motion-compensated image MH is explained in more detail below. A high-resolution image RH, which is a reference image of the input picture, is provided from the frame memory 907 to the down-conversion unit 919 and the picture processing unit 100 (800). The down-conversion unit 919 down-converts resolution of the high-resolution image RH, thereby generating a low-resolution image RL, which is also provided to the picture processing unit 100 (800). A low-resolution image CL, which is the down-converted image of the input picture, is provided through the switch 916 to the picture processing unit 100 (800). Using the high-resolution image RH, the low-resolution image RL, and the low-resolution CL, the high-resolution motion-compensated image MH is generated in the picture processing unit 100. For example, in order to generate a high-resolution motion-compensated picture of a picture B4 in FIG. 11(b), a part or all of pictures I0, P3, and P6 are used as high-resolution reference pictures RH. Moreover, in order to generate a high-resolution motion-compensated picture of a picture B4 in FIG. 11(c), a picture I0 is used as a high-resolution reference picture RH.

A different example regarding generation of a motion-compensated image MH, which is not shown in figures, is given below. In this example, it is assumed that pictures are to be coded in an order of I0, P3, B1, and B2, and that the pictures I0 and B2 are to be coded as high-resolution pictures, while the pictures P3 and B1 are to be coded as low-resolution pictures. In this case, the picture I0 is directly applied with intra prediction coding as a high-resolution picture. Then, the picture P3 is down-converted by the down-conversion unit 918 to be a low-resolution picture. This down-converted picture P3 is coded referring to the picture I0, so that resolution of the picture I0, which is a reference picture for the picture P3, is also down-converted by the down-conversion unit 919 and the resulting low-resolution picture is stored in the frame memory 907. The intra prediction/motion estimation unit 908 performs motion estimation between the picture P3 and the down-converted IO, thereby generating a low-resolution motion-compensated picture of the picture P3. The generated low-resolution motion-compensated picture is provided to the difference operation unit 902 through the mode selection unit 909. The difference operation unit 902 calculates a residual between the low-resolution picture P3 and the low-resolution motion-compensated picture, and the residual is coded by the residual coding unit 903. The coded residual of the low-resolution picture P3 is passed via the switch 915 to the residual decoding unit 905. The residual decoding unit 905 decodes the coded residual to generate a decoded low-resolution differential image. The coded differential image is added with the low-resolution motion-compensated image of the picture P3 by the addition operation unit 906, thereby generating a partly-decoded image. The obtained low-resolution partly-decoded image is passed through the switches 916 and 917 and accumulated in the frame memory 907.

Next, the low-resolution partly-decoded image of the picture P3 is referred to by the picture B2 which is coded as a high-resolution picture. Therefore, resolution of the picture P3 is up-converted by the picture processing unit 100 (or 800) to be a high-resolution picture, and the up-converted picture is accumulated in the frame memory 907. Here, it is assumed that a low-resolution picture CL is the picture P3, that a high-resolution reference picture RH referred to by the picture P3 is the picture I0 accumulated in the frame memory 907, and that a low-resolution reference picture RL referred to by the picture P3 is a low-resolution picture which is generated by reading the picture I0 from the frame memory 907 and down-converting the read-out picture I0 by the down-conversion unit 919. Using the low-resolution picture CL, the high-resolution reference picture RH, and the low-resolution reference picture RL, a high-resolution motion-compensated picture MH of the picture P3 is generated in the same manner as described in the first embodiment. As a result, the picture B2, which is to be coded as a high-resolution picture, is applied with motion estimation and motion compensation, referring to the high-resolution picture I0 stored in the frame memory 907, and the high-resolution picture P3 (high-resolution motion-compensated picture MH).

Now, referring back to FIG. 10, the description is returned to the explanation of how a picture data generated during the above-described coding method is used as a reference image for other pictures. Here, on the other hands, if resolution of the input picture has not been down-converted by the down-conversion unit 918, then the coding control unit 910 connects the switch 916 to the terminal k, and connects the switch 917 to the terminal i. Therefore, in this situation, the data inputted into the switch 916 is outputted from the switch 917 without any processing.

The image outputted from the switch 917 is accumulated in the frame memory 907. In the same coding method as described above, other remaining macrobloks in the to-be-coded input picture are also coded.

As described above, in the picture coding method of the present invention, some of the high-resolution input pictures are applied with low-resolution conversion to be coded. Such a picture, which has been applied with the low-resolution conversion and the coding, is later applied with high-resolution conversion using the picture processing method of the present invention, so that the converted high-resolution picture can be used as a reference picture in coding of other pictures.

By using the picture coding method of the present invention, it is possible to significantly reduce a coding amount required to convert an input picture into a low-resolution picture. Further, a picture which has been converted into a low-resolution picture is later converted into a high-resolution picture having high image quality using the picture processing method of the present invention. Thereby, even if the picture which has been converted into a low-resolution picture is used as a reference picture, motion compensation efficiency is hardly reduced compared to a reference picture which has not been converted into a low-resolution picture. Thus, it is possible to significantly improve overall coding efficiency.

Note that the fourth embodiment has been described that decoded images are generated from only pictures which are to be used as reference pictures in coding of other pictures, by turning on the switch 915. However, the picture processing unit 100 (800) may also generate decoded imaged from pictures which are to be used as reference pictures in high-resolution conversion processing, by turning on the switch 915.

### Variation of Fourth Embodiment

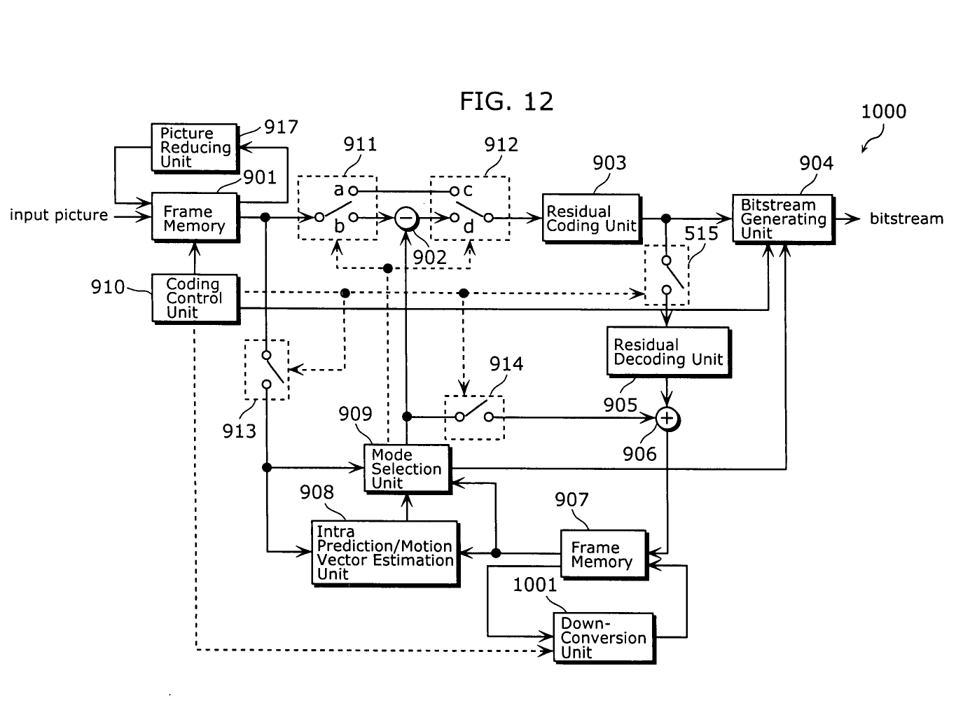

A variation of the fourth embodiment 4 is described with reference to FIG. 12. FIG. 12 is a block diagram showing a structure of a picture coding device 1000 according to the variation of the fourth embodiment. The picture coding device 1000 has the basically same structure of the picture coding device 900 of FIG. 10, but does not include the switches 916 and 917, the picture processing unit 100 (800), nor the down-conversion unit 919, and adds a down-conversion unit 1001.

The variation differs from the fourth embodiment in that pictures which are coded as high-resolution pictures do not refer to pictures which are coded as low-resolution pictures. Therefore, pictures, which have been converted into low-resolution pictures and decoded partly, are not later converted into high-resolution pictures but accumulated directly into the frame memory 907. Then, when the pictures which have been coded as high-resolution pictures are used as reference pictures in coding of pictures which are coded as low-resolution pictures, resolution of the decoded pictures accumulated in the frame memory 907 is down-converted by the down-conversion unit 1001, then the resulting low-resolution pictures are accumulated again in the frame memory 907, and used as reference pictures. For example, regarding the picture I0 in FIG. 11(b), a high-resolution decoded picture is temporarily accumulated into the frame memory 907. Then, when the picture P3 is coded, the decoded picture of the picture I0 is not applied with resolution conversion but used as a reference picture, and a decoded picture of the picture P3 is temporarily accumulated into the frame memory 907 as the high-resolution picture. The picture B1 is converted into a low-resolution picture and coded, so that resolution of decoded images of the pictures I0 and P3 is down-converted by the down-conversion unit 1001 and then the resulting low-resolution images are used as reference pictures for the picture B1. This is the same in the case of FIG. 11(c), where only I-pictures are coded as high-resolution pictures and P- and B-pictures are coded as low-resolution pictures. In this case, low-resolution conversion is necessary when I-pictures are referred to by other pictures, while high-resolution conversion is not necessary.

Note that the coding control unit 910 corresponds to an unit executing “deciding, where it is decided that an I-picture and a P-picture are coded as high-resolution pictures, and a B-picture is coded as a low-resolution picture, assuming that the B-picture is not referred to by any other pictures”, in the claims appended to the specification.

Note also that the coding control unit 910 corresponds to an unit executing “deciding, where it is decided that only I-picture is coded as a high-resolution picture”, in the claims appended to the specification.

As described above, in the picture coding method of the present invention, when high-resolution pictures are coded, some of the pictures are converted into low-resolution pictures and coded. Then, when a picture is converted into a low-resolution picture and coded, if a reference picture is a high-resolution picture, the reference picture is converted into a low-resolution picture and coded.

By using the picture coding method of the present invention, a great number of input pictures are converted into low-resolution pictures and coded, so that it is possible to significantly reduce resulting coding amount.

### Fifth Embodiment

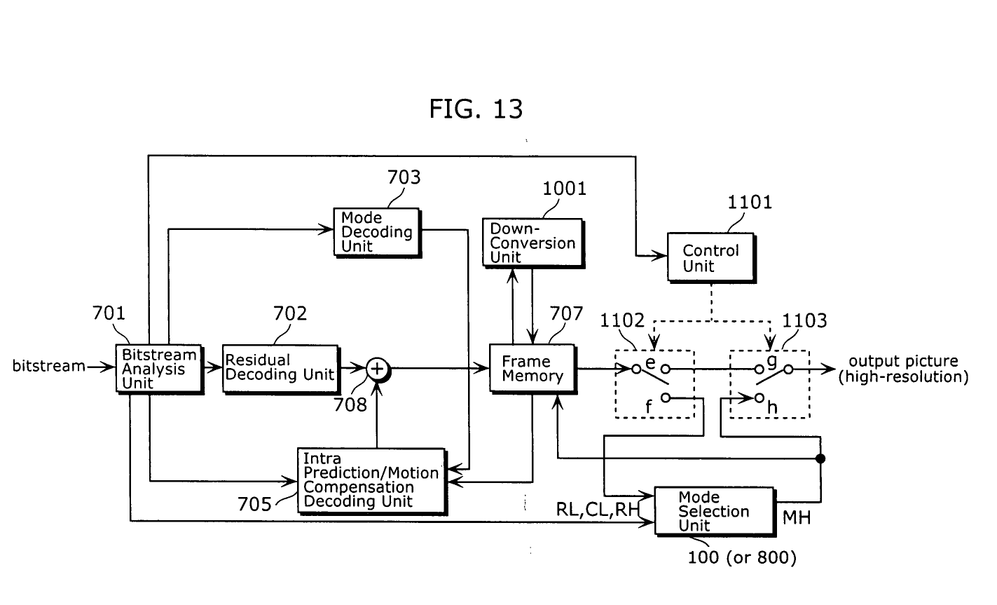

The fifth embodiment describes another picture decoding method according to the present invention with reference to FIG. 13. FIG. 13 is a block diagram showing a structure of a picture decoding device, by which a decoded low-resolution picture is converted into a high-resolution picture to be outputted in post-processing of the decoding. The picture decoding device of the fifth embodiment is a picture decoding device which decodes a low-resolution coded picture, and then converts the decoded picture into a high-resolution picture using the picture processing unit of the present invention. This picture decoding device includes a bitstream analysis unit 701, a residual decoding unit 702, a mode decoding unit 703, an intra prediction/motion compensation decoding unit 705, a frame memory 707, an addition operation unit 708, a down-conversion unit 1001, a control unit 1101, switches 1102 and 1103, and the picture processing unit 100 (or 800). The following describes processing for decoding a P-picture.

Here, in FIG. 13, the bitstream analysis unit 701, the residual decoding unit 702, and the intra prediction/motion compensation decoding unit 705 correspond to “a decoding unit operable to decode a to-be-decoded picture coded in the bitstream”, the picture processing unit 100 (or 800) corresponds to “a decoded-picture processing unit operable to up-convert resolution of a low-resolution decoded picture to generate a high-resolution picture, when the decoded picture has been coded as a low-resolution picture”, and the frame memory 707, the switch 1102, the switch 1103, and the control unit 1101 correspond to ” an output unit operable to output the high-resolution picture whose resolution is up-converted in said decoded-picture processing unit”, in one of the claims appended to the specification.

Further, the picture processing unit 100 (or 800) corresponds to “up-converting includes: estimating a motion vector, per one or more pixels, for a first low-resolution picture from a second low-resolution picture, the first low-resolution picture being decoded in said decoding, and the second low-resolution being decoded in said decoding and having been used as a reference picture in coding of the first low-resolution picture; obtaining, based on the estimated motion vector, a pixel value of a pixel in a second high-resolution picture which corresponds to the pixel used in said estimating, the second high-resolution picture representing the same image of the second low-resolution picture but having different resolution; and generating a first high-resolution picture using the obtained pixel value, in order to be outputted as the high-resolution picture in said outputting, the first high-resolution picture representing the same image of the first low-resolution picture but having different resolution”, in the claims appended to the specification.

A bitstream of a P-picture is inputted to the bitstream analysis unit 701. The bitstream analysis unit 701 extracts various data from the input bitstream. Here, the various data includes the mode selection information, the motion vector information, the header information, and the like. The extracted mode selection information is provided to the mode decoding unit 703. The extracted intra prediction method information or the motion vector information is provided to the intra prediction/motion compensation decoding unit 705. The residual coded data is provided to the residual decoding unit 702. Here, when the bitstream describes, as header information, flag information indicating what kind of processing method has been used for the coding of the picture by the picture processing unit 100 (or 800), this flag information is provided to the picture processing unit 100 (or 800). More specifically, this flag information indicates: which method has been used for motion estimation by the picture processing unit 100 (or 800); which methods have been used to generate motion-compensated images; which motion-compensated image has been selected from the generated motion-compensated images; which criteria has been used in the selection of the motion-compensated image; and which range has been used in searching in the high-resolution reference image RH; and the like.

The mode decoding unit 703 decodes the provided mode selection information to be outputted to the intra prediction/motion compensation decoding unit 705.

The residual decoding unit 702 decodes the provided residual coded data to generate a residual image. The generated residual image is passed to the addition operation unit 708.

The intra prediction/motion compensation decoding unit 705 obtains an intra prediction image or a motion-compensated image (block) from the frame memory 707, depending on the intra prediction method or the motion vector provided from the bitstream analysis unit 701, in order to generate an intra prediction image or a motion-compensated image. The generated intra prediction image or motion-compensated image is passed to the addition operation unit 708.

The addition operation unit 708 adds the provided residual image with the intra prediction picture or the motion-compensated image, thereby generating a decoded image. The generated decoded image is accumulated into the frame memory 707.

Note that, when the decoded image accumulated in the frame memory 707 is a high-resolution picture and to be used as a reference picture in decoding of other pictures which has been coded as low-resolution pictures, resolution of the decoded image is down-converted by the down-conversion unit 1001 so that the resulting low-resolution image is used as a reference picture.

Then, the decoded image accumulated in the frame memory 707 is inputted into the switch 1102. The Switches 1102 and 1103 are controlled by the control unit 1101.

Here, if, as mentioned above, the decoded image accumulated in the frame memory 707 is a high-resolution picture, in other words, if the decoded image is obtained by decoding a coded image whose resolution is not down-converted, then the control unit 1101 connects the switch 1102 to a terminal e, and connects the switch 1103 to a terminal g, so that the decoded image accumulated in the frame memory 707 is directly outputted as an output image. This processing is performed for I- and P-pictures, in the case where, for example, pictures have been coded as shown in FIG. 11(b). Further, this processing is performed for I-pictures, in the case where, for example, pictures have been coded as shown in FIG. 11(c). The control unit 1101 can control the switch 1102 and the switch 1103, depending on information such as picture type and picture size. Those information can be obtained from the bitstream analysis unit 701.

On the other hand, if the decoded image accumulated in the frame memory 707 is a low-resolution picture, in other words, if the decoded image is obtained by decoding a coded image whose resolution has been down-converted, then the control unit 1101 connects the switch 1102 to a terminal f, and connects the switch 1103 to a terminal h. In this case, the decoded image accumulated in the frame memory 707 is provided to the picture processing unit 100 (800). The picture processing unit 100 (800) is further provided from the frame memory 707 with: a low-resolution reference image RL; a low-resolution image CL generated from the target P-picture; and a high-resolution decoded image RH generated from the same reference image of the low-resolution image RL. When the low-resolution image CL or RL is not accumulated in the frame memory 707, resolution of a high-resolution image generated from the same image of the low-resolution image is down-converted by the down-conversion unit 1001 to generate a low-resolution image. Then, the picture processing unit 100 (800) generates a high-resolution motion-compensated image MH, in the same manner as described in the first embodiment of the present invention or the variation of the first embodiment. The generated high-resolution motion-compensated image MH is outputted as an output image through the switch 1103, instead of the decoded low-resolution image. When the high-resolution motion-compensated image MH is to be used in decoding or high-resolution conversion of other pictures, the high-resolution motion-compensated image MH is accumulated in the frame memory 707. As described above, it is possible to obtain a decoded image sequence of high-resolution pictures as shown in FIG. 11(a).

Thus, by the picture decoding method of the present invention, a bitstream, in which each picture has been coded as a low-resolution picture or a high-resolution picture, is decoded. When a picture, which has been coded as a low-resolution picture, is decoded, a motion vector is estimated from a low-resolution reference picture, and, using the motion vector and a high-resolution reference picture generated from the same picture of the low-resolution reference picture, a high-resolution motion compensated picture is generated. By such a processing, a picture which has been coded as a low-resolution picture can be converted into a high-resolution picture with a less coding amount, so that it is possible to reproduce all pictures as high-resolution pictures with less coding amounts, which results in significant improvement in coding efficiency.

### Variation of Fifth Embodiment

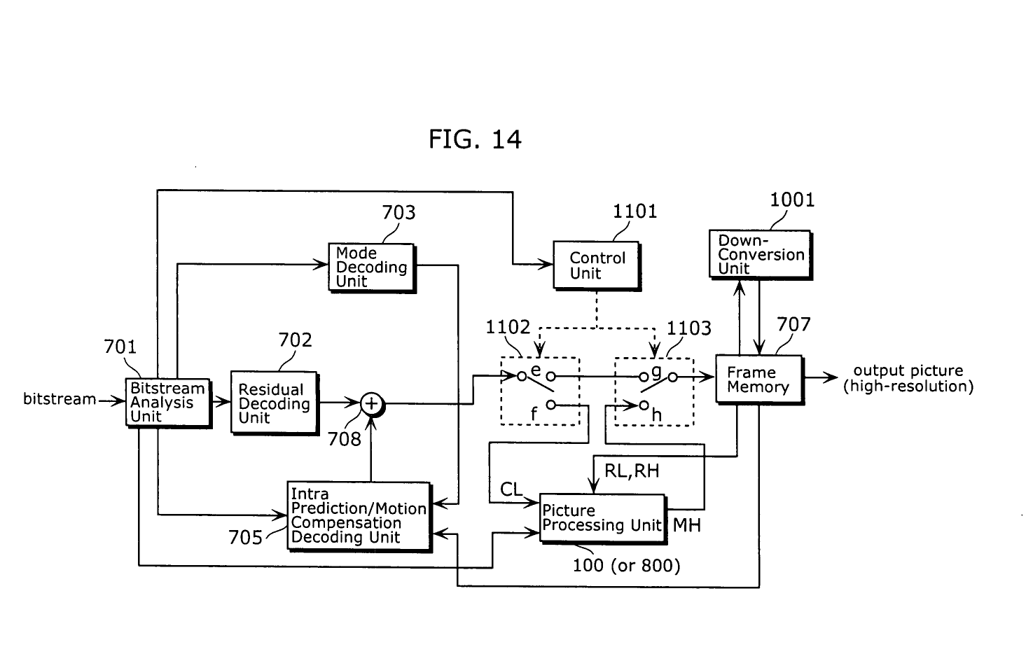

A variation of the fifth embodiment is described with reference to FIG. 14. FIG. 14 is a block diagram showing a structure of a picture decoding device according to a variation of the fifth embodiment. The picture decoding device of this variation differs from the picture decoding device of the fifth embodiment in that an order of the frame memory 707 and the picture processing unit 100 (800) is opposite.

Here, it is assumed that a decoded image is outputted from the addition operation unit 708 to the switch 1102. The decoded image is processed by the control unit 1101, the switch 1102, the switch 1103, and the picture processing unit 100 (800), in the same manner as described in the fifth embodiment. More specifically, if the decoded image is a high-resolution picture, in other words, if the decoded image is obtained by decoding a coded image whose resolution is not down-converted, the decoded image is directly accumulated into the frame memory 707. On the other hand, if the decoded image is a low-resolution picture, in other words, if the decoded image is obtained by decoding a coded image whose resolution has been down-converted, the decoded image is converted into a high-resolution picture by the picture processing unit 100 (800) and accumulated into the frame memory 707.

The decoded image accumulated in the frame memory 707 is outputted as an output image. The decoded image is used in decoding or high-resolution conversion of other pictures.

As described above, the picture decoding device of the present invention decodes a bitstream, in which each picture has been coded as a low-resolution picture or a high-resolution picture. When a picture, which has been coded as a low-resolution picture, is decoded, a motion vector is estimated per pixel from a low-resolution reference picture per pixel, and a high-resolution motion-compensated picture is generated using the motion vector from a high-resolution reference picture generated from the same picture of the low-resolution reference picture, and is outputted instead of the decoded low-resolution picture. By such a processing, it is possible to significantly improve coding efficiency.

### Sixth Embodiment

Furthermore, the picture processing method, the picture coding method, and the picture decoding method described in the above embodiments can be realized by a program which is recorded on a recording medium such as a flexible disk. Thereby, it is possible to easily perform the processing as described in the embodiments in an independent computer system.

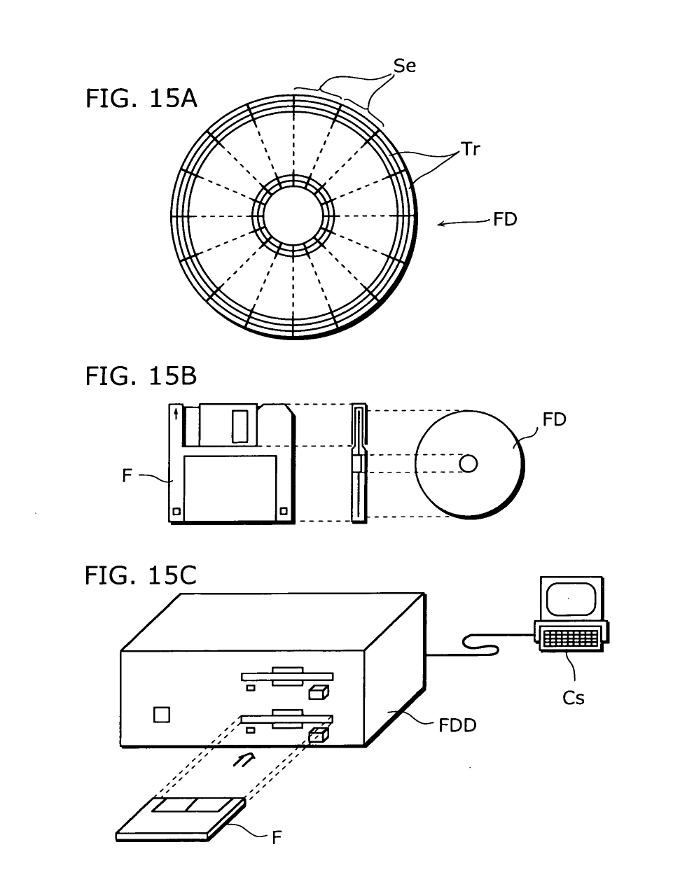

FIGS. 15A, 15B, and 15C are explanatory diagrams, where the picture processing method, the picture coding method, and the picture decoding method described in the above embodiments are realized in a computer system using a program recorded in a recording medium, such as flexible disk.

FIG. 15B shows a front view and a cross-sectional view of a case of the flexible disk, and a view of the flexible disk itself, and FIG. 15A shows an example of a physical format of the flexible disk, as a recording medium body. The flexible disk FD is contained in the case F, and on a surface of the disk, a plurality of tracks Tr are formed concentrically from the outer periphery to the inner periphery, and each track is segmented into sixteen sectors Se in an angular direction. Therefore, in the flexible disk storing the above-described program, the program is recorded in an area allocated on the above flexible disk FD

Moreover, FIG. 15C shows a structure for recording and reproducing the above program on the flexible disk FD. When the program realizing the picture processing method, the picture coding method, and the picture decoding method is recorded onto the flexible disk FD, the program is written from a computer system Cs via a flexible disk drive. When the above picture processing method, the picture coding method, and the picture decoding method are constructed in the computer system using the program in the flexible disk, the program is read out from the flexible disk via the flexible disk drive and transferred to the computer system.

Note that the above has described that the recording medium is assumed to be the flexible disk, but the recording medium may be an optical disk. Note also that, the recording medium is not limited to the above mediums, but any other mediums, such as an IC card and a ROM cassette, can be also used, as far as the mediums can record the program.

### Seventh Embodiment

Furthermore, the applications of the picture processing method, the picture coding method, and the picture decoding method described in the above embodiments, and a system using such applications are described here.

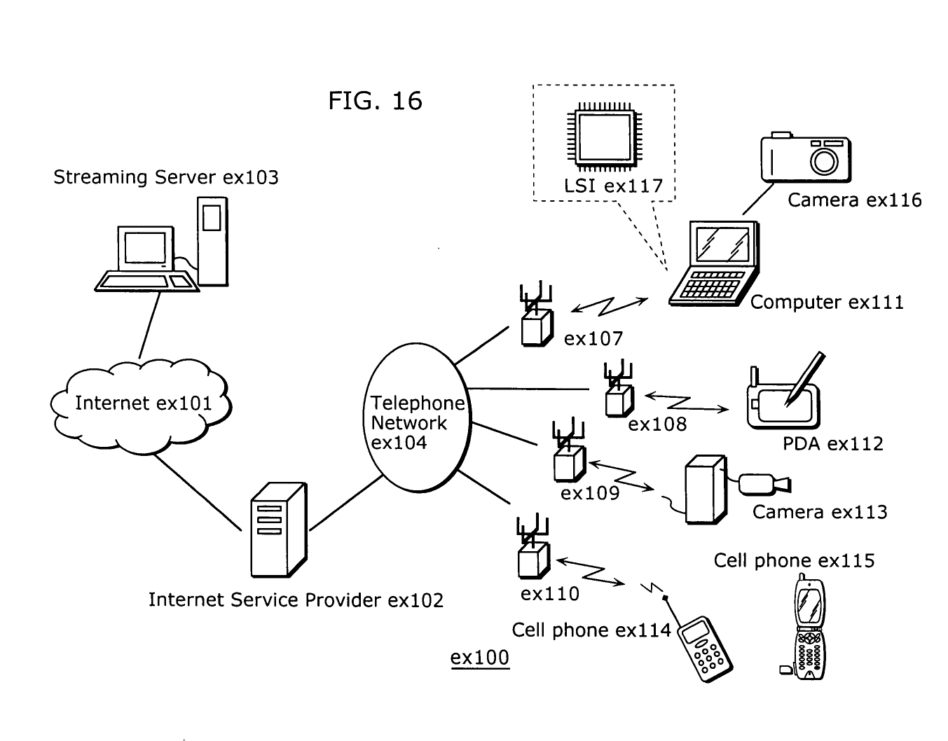

FIG. 16 is a block diagram showing the overall configuration of a content supply system ex100 for realizing content distribution service. The area for providing communication service is divided into cells of desired size, and base stations ex107 to ex110 which are fixed wireless stations are placed in respective cells.

In this content supply system ex100, various devices such as a computer ex111, a personal digital assistant (PDA) ex112, a camera ex113, a cell phone ex114 and a camera-equipped cell phone ex115 are connected to the Internet ex101, via an Internet service provider ex102, a telephone network ex104 and base stations ex107 to ex110, for example.

However, the content supply system ex100 is not limited to the combination as shown in FIG. 16, and may include a combination of any of these devices which are connected to each other. Also, each device may be connected directly to the telephone network ex104, not through the base stations ex107 to ex110 which are the fixed wireless stations.

The camera ex113 is a device such as a digital video camera capable of shooting moving pictures. The cell phone may be any of a cell phone of a Personal Digital Communications (PDC) system, a Code Division Multiple Access (CDMA) system, a Wideband-Code Division Multiple Access (W-CDMA) system and a Global System for Mobile Communications (GSM) system, a Personal Handy-phone System (PHS), and the like.

Also, a streaming server ex103 is connected to the camera ex113 via the base station ex109 and the telephone network ex104, which realizes live distribution or the like using the camera ex113 based on the coded data transmitted from the user. The coding of the data shot by the camera may be performed by the camera ex113, the server for transmitting the data, or the like. Also, the moving picture data shot by a camera ex116 may be transmitted to the streaming server ex103 via the computer ex111. The camera ex116 is a device such as a digital camera capable of shooting still and moving pictures. In this case, either the computer ex111 or the camera ex116 may code the moving picture data. An LSI ex117 included in the computer ex111 or the camera ex116 performs the coding processing. Note that software for coding and decoding pictures may be integrated into any type of a recording medium (such as a CD-ROM, a flexible disk and a hard disk) that is readable by the computer ex111 or the like. Furthermore, the camera-equipped cell phone ex115 may transmit the moving picture data. This moving picture data is the data coded by the LSI included in the cell phone ex115.

In this content supply system ex100, contents (such as a video of a live music performance) shot by users using the camera ex113, the camera ex116 or the like are coded in the same manner as in the above embodiments and transmitted to the streaming server ex103, while the streaming server ex103 makes stream distribution of the above content data to the clients at their requests. The clients include the computer ex111, the PDA ex112, the camera ex113, the cell phone ex114, and the like, capable of decoding the above-mentioned coded data. The content supply system ex100 is a system in which the clients can thus receive and reproduce the coded data, and further can receive, decode and reproduce the data in real time so as to realize personal broadcasting.

When each device included in this system performs coding or decoding, the picture coding device or the picture decoding device described in the above embodiments may be used.

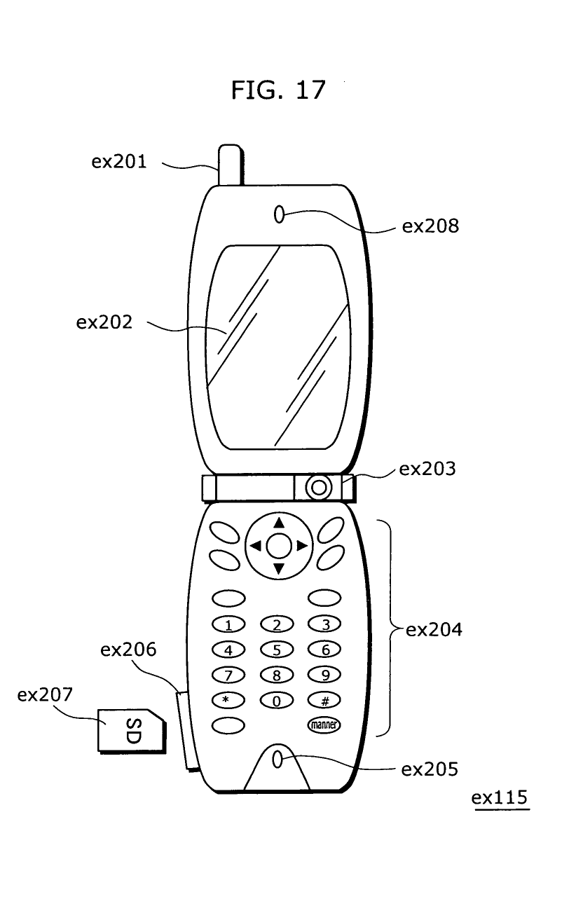

A cell phone is now described as an example thereof. FIG. 17 is a diagram showing a cell phone ex115 which uses the picture coding device and the picture decoding device as described in the above embodiments. The cell phone ex115 has: an antenna ex201 for communicating radio waves with the base station ex111; a camera unit ex203 such as a CCD camera capable of shooting moving and still pictures; a display unit ex202 such as a liquid crystal display for displaying the data obtained by decoding video shot by the camera unit ex203, video received by the antenna ex201, or the like; a main body including a set of operation keys ex204; a voice output unit ex208 such as a speaker for outputting sounds; a voice input unit ex205 such as a microphone for inputting voices; a recording medium ex207 for storing coded or decoded data, such as data of moving or still pictures shot by the camera, and data of text, moving pictures or still pictures of received e-mails; and a slot unit ex206 for attaching the recording medium ex207 into the cell phone ex115. The recording medium ex207 includes a flash memory element, a kind of Electrically Erasable and Programmable Read Only Memory (EEPROM) that is an electrically rewritable and erasable nonvolatile memory, in a plastic case such as an SD card.

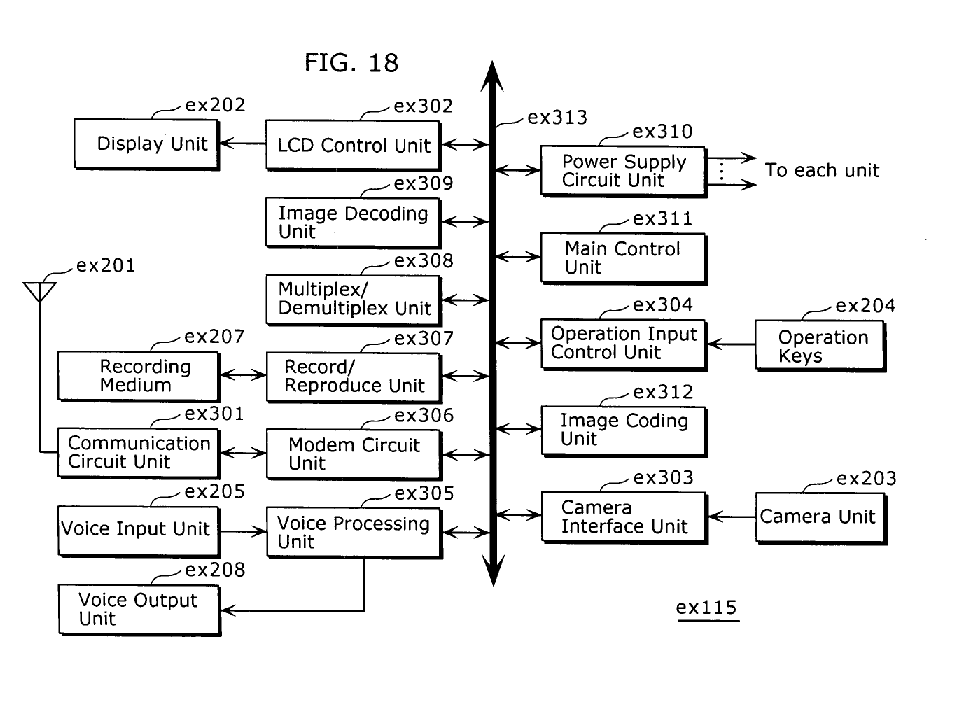

Furthermore, the cell phone ex115 is described with reference to FIG. 18. In the cell phone ex115, a power supply circuit unit ex310, an operation input control unit ex304, an image coding unit ex312, a camera interface unit ex303, an Liquid Crystal Display (LCD) control unit ex302, an image decoding unit ex309, a multiplex/demultiplex unit ex308, a record/reproduce unit ex307, a modem circuit unit ex306 and a voice processing unit ex305, are connected with each other via a synchronous bus ex313, and to a main control unit ex311 which controls all of the units in the body including the display unit ex202 and the operation keys ex204.

When a call-end key or a power key is turned ON by a user's operation, the power supply circuit unit ex310 supplies the respective units with power from a battery pack so as to activate the camera-equipped digital cell phone ex115 to a ready state.

In the cell phone ex115, under the control of the main control unit ex311 including a CPU, ROM, RAM and the like, the voice processing unit ex305 converts the voice signals received by the voice input unit ex205 in voice conversation mode into digital voice data, the modem circuit unit ex306 performs spread spectrum processing of the digital voice data, and the communication circuit unit ex301 performs digital-to-analog conversion and frequency transformation of the data, so as to transmit the resulting data via the antenna ex201. Also, in the cell phone ex115, the data received by the antenna ex201 in voice conversation mode is amplified and subjected to the frequency transformation and analog-to-digital conversion, the modem circuit unit ex306 performs inverse spread spectrum processing of the data, and the voice processing unit ex305 converts it into analog voice data, so as to output the resulting data via the voice output unit ex208.

Furthermore, when transmitting an e-mail in data communication mode, the text data of the e-mail inputted by operating the operation keys ex204 of the main body is sent out to the main control unit ex311 via the operation input control unit ex304. After the modem circuit unit ex306 performs spread spectrum processing of the text data and the communication circuit unit ex301 performs a digital-to-analog conversion and frequency transformation on the text data, the main control unit ex311 transmits the data to the base station ex110 via the antenna ex201.

When transmitting picture data in data communication mode, the picture data shot by the camera unit ex203 is provided to the image coding unit ex312 via the camera interface unit ex303. When the picture data is not transmitted, the picture data shot by the camera unit ex203 can also be displayed directly on the display unit 202 via the camera interface unit ex303 and the LCD control unit ex302.

The image coding unit ex312, including the picture coding device described in the present invention, compresses and codes the picture data provided from the camera unit ex203 by the picture coding method used in the picture coding device as described in the above embodiments so as to convert it into coded picture data, and sends it out to the multiplex/demultiplex unit ex308. At this time, the cell phone ex115 sends out the voices received by the voice input unit ex205 during the shooting by the camera unit ex203, as digital voice data, to the multiplex/demultiplex unit ex308 via the voice processing unit ex305.

The multiplex/demultiplex unit ex308 multiplexes the coded picture data provided from the image coding unit ex312 and the voice data provided from the voice processing unit ex305, and the modem circuit unit ex306 then performs spread spectrum processing of the multiplexed data obtained as the result of the processing, and the communication circuit unit ex301 performs digital-to-analog conversion and frequency transformation on the resulting data and transmits it via the antenna ex201.

As for receiving data of a moving picture file which is linked to a website or the like in data communication mode, the modem circuit unit ex306 performs inverse spread spectrum processing of the data received from the base station ex510 via the antenna ex201, and sends out the multiplexed data obtained as the result of the processing to the multiplex/demultiplex unit ex308.

In order to decode the multiplexed data received via the antenna ex201, the multiplex/demultiplex unit ex308 demultiplexes the multiplexed data into a coded bit stream of image data and a coded bit stream of voice data, and provides the coded image data to the image decoding unit ex309 and the voice data to the voice processing unit ex305, respectively, via the synchronous bus ex313.

Next, the image decoding unit ex309, including the picture decoding device described in the present invention, decodes the coded bit stream of the picture data using the decoding method corresponding to the coding method as described in the above embodiments, so as to generate reproduced moving picture data, and provides this data to the display unit ex202 via the LCD control unit ex302, and thus moving picture data included in a moving picture file linked to a website, for instance, is displayed. At the same time, the voice processing unit ex305 converts the voice data into analog voice data, and provides this data to the voice output unit ex208, and thus voice data included in a moving picture file linked to a website, for instance, is reproduced.

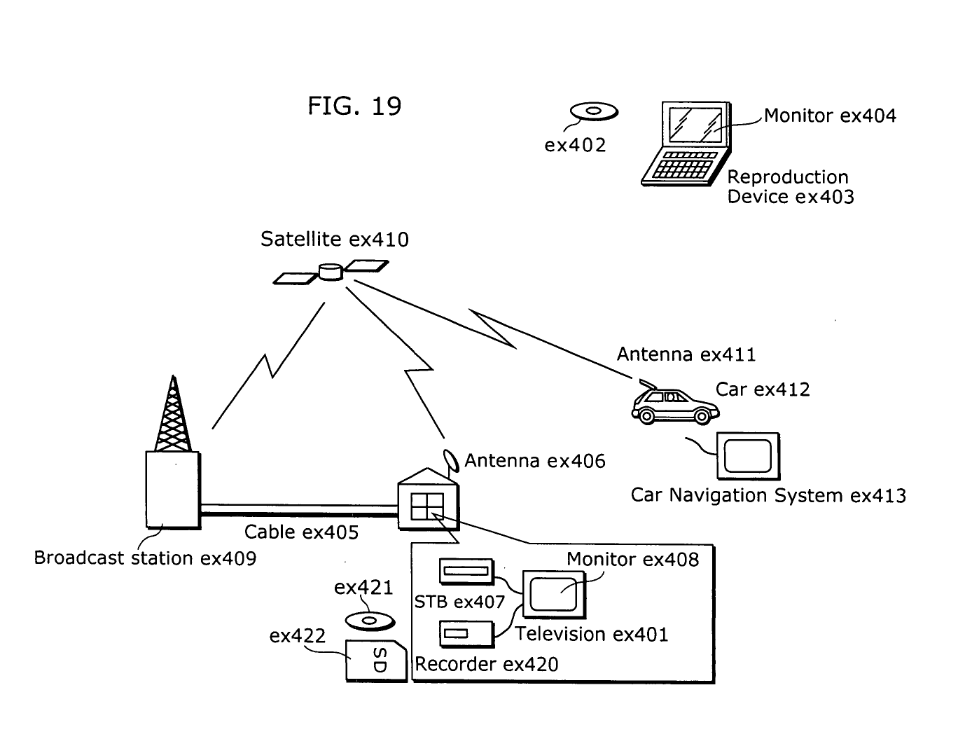

The present invention is not limited to the above-mentioned system since satellite or terrestrial digital broadcasting has been in the news lately, and at least either the picture coding device or the picture decoding device described in the above embodiments can be incorporated into the digital broadcasting system as shown in FIG. 19. More specifically, a coded bit stream of video information is transmitted from a broadcast station ex409 to a communication or broadcast satellite ex410 via radio waves. Upon receipt of it, the broadcast satellite ex410 transmits radio waves for broadcasting, a home antenna ex406 with a satellite broadcast reception function receives the radio waves, and a device such as a television (receiver) ex401 or a Set Top Box (STB) ex407 decodes the coded bit stream for reproduction. The picture decoding device described in the above embodiments can be implemented in a reproduction device ex403 for reading and decoding a coded bit stream recorded on a storage medium ex402 such as a CD and DVD that is a recording medium. In this case, the reproduced video signals are displayed on a monitor ex404. It is also conceived to implement the picture decoding device in the set top box ex407 connected to a cable ex405 for cable television or the antenna ex406 for satellite and/or terrestrial broadcasting so as to reproduce them on a monitor ex408 of the television. The picture decoding device may be incorporated into the television, not in the set top box. Also, a car ex412 having an antenna ex411 can receive signals from the satellite ex410, the base station ex107 or the like, and reproduce moving pictures on a display device such as a car navigation system ex413 or the like in the car ex412.

Furthermore, the picture coding device as described in the above embodiments can code image signals and record them on a recording medium. As a concrete example, there is a recorder ex420 such as a DVD recorder for recording image signals on a DVD disk ex421 and a disk recorder for recording them on a hard disk. They can also be recorded on an SD card ex422. If the recorder ex420 includes the picture decoding device as described in the above embodiments, the image signals recorded on the DVD disk ex421 or the SD card ex422 can be reproduced for display on a monitor ex408.

As for the configuration of the car navigation system ex413, a configuration without the camera unit ex203, the camera interface unit ex303 and the image coding unit ex312, out of the units as shown in FIG. 18, is conceivable. The same applies to the computer ex111, the television (receiver) ex401, and others.

Moreover, three types of implementations can be conceived for a terminal such as the above-mentioned cell phone ex114: a communication terminal equipped with both an encoder and a decoder; a sending terminal equipped with an encoder only; and a receiving terminal equipped with a decoder only.

Thus, the picture processing method, the picture coding method, and the picture decoding method described in the above embodiments can be used in any of the above-described apparatuses and systems, and thereby the effects described in the above embodiments can be obtained.

Note also that functional blocks in the block diagrams shown in FIGS. 1, 5, 7, 9, 10, and 12 to 14 are implemented into a LSI which is an integrated circuit. These may be integrated separately, or a part or all of them may be integrated into a single chip. (For example, functional blocks except a memory may be integrated into a single chip.) Here, the integrated circuit is referred to as a LSI, but the integrated circuit can be called an IC, a system LSI, a super LSI or an ultra LSI depending on their degrees of integration.

Note also that the technique of integrated circuit is not limited to the LSI, and it may be implemented as a dedicated circuit or a general-purpose processor. It is also possible to use a Field Programmable Gate Array (FPGA) that can be programmed after manufacturing the LSI, or a reconfigurable processor in which connection and setting of circuit cells inside the LSI can be reconfigured.

Furthermore, if due to the progress of semiconductor technologies or their derivations, new technologies for integrated circuits appear to be replaced with the LSIs, it is, of course, possible to use such technologies to implement the functional blocks as an integrated circuit. For example, biotechnology and the like can be applied to the above implementation.

Note also that a central part of the functional blocks shown in FIGS. 1, 5, 7, 9, 10, and 12 to 14 is realized as a processor and a program.

Note that the present invention is not limited to the above embodiments but various variations and modifications are possible in the embodiments without departing from the scope of the present invention.

### INDUSTRIAL APPLICABILITY

The picture processing method, the picture coding method, and the picture decoding method according to the present invention are capable of reducing a coding amount, in high efficiency coding of input pictures. These methods are useful for data accumulating, data transmitting, and communication, and the like.

What is claimed is:

1. A picture coding method of coding a high-resolution input picture to be one of a high-resolution picture and a low-resolution picture, said method comprising:
deciding whether or not a to-be-coded picture is to be coded as a high-resolution picture or a low-resolution picture, depending on a picture type of the to-be-coded picture;
down-converting resolution of the to-be-coded picture, when the to-be-coded picture is decided to be coded as a low-resolution picture in said deciding;
down-converting resolution of a reference picture which has been coded as a high-resolution picture, when the reference picture is referred to by the to-be-coded picture decided to be coded as a low-resolution picture in said deciding; and
coding the to-be-coded picture whose resolution is down-converted in said down-converting of the resolution of the to-be-coded picture, referring to the reference picture whose resolution is down-converted in said down-converting of the resolution of the reference picture.

2. The picture coding method according to claim 1,
wherein in said deciding, it is decided that an I-picture and a P-picture are coded as high-resolution pictures, and a B-picture is coded as a low-resolution picture, assuming that the B-picture is not referred to by any other pictures.

3. The picture coding method according to claim 1,
wherein in said deciding, it is decided that only I-picture is coded as a high-resolution picture.

4. The picture coding method according to claim 1 further comprising
up-converting resolution of a reference picture which has been coded as a low-resolution picture, when the reference picture is referred to by the to-be-coded picture decided to be coded as a high-resolution picture in said deciding,
wherein, in said coding, the to-be-coded picture refers to the reference picture whose resolution is up-converted in said up-converting.

5. The picture coding method according to claim 4,
wherein said up-converting includes:
estimating a motion vector, per one or more pixels, for a first low-resolution picture from a second low-resolution picture, the first low-resolution picture being the reference picture of to-be-coded picture and coded as a low-resolution picture, and the second low-resolution picture being a reference picture of the first low-resolution picture in the coding of the first low-resolution picture;
obtaining, based on the estimated motion vector, a first pixel value of a pixel in a second high-resolution picture which corresponds to the pixel used in said estimating, the second high-resolution picture representing the same image as the second low-resolution picture but having different resolution; and
generating a first high-resolution picture, by using the obtained first pixel value, in order to be used as the actual reference picture of the to-be-coded picture, the first high-resolution picture representing the same image as the first low-resolution picture but having different resolution.

6. The picture coding method according to claim 5,
wherein sad up-converting further includes:
estimating a motion vector for the first high-resolution picture from the second high-resolution picture, per one or more pixels each of which has been already generated in the first high-resolution picture;
obtaining, based on the estimated motion vector, a second pixel value of a pixel in the second high-resolution picture which is positioned at the same location as the pixel in the first high-resolution picture; and
generating the first high-resolution picture, by using the an average value of the obtained first and second pixel values in a corresponding pixel, in order to be used as the actual reference picture of the to-be-coded picture.

7. The picture coding method according to claim 5,
wherein sad up-converting further includes:
estimating a plurality of motion vectors, regarding already-generated pixels, for the first low-resolution picture from a plurality of the second low-resolution pictures, and for the first high-resolution picture from a plurality of the second high-resolution pictures; and
generates a plurality of the first high-resolution pictures, using a plurality of the estimated motion vectors, and
said coding further includes
selecting one of the plurality of the high-resolution pictures generated in said up-converting, in order to be used as the actual reference picture of the to-be-coded picture.

8. A picture decoding method of decoding a bitstream in which each moving picture is coded as a high-resolution picture or a low-resolution picture, said method comprising:
decoding a to-be-decoded picture coded in the bitstream;
up-converting resolution of a low-resolution decoded picture to generate a high-resolution picture, when the decoded picture has been coded as a low-resolution picture; and
outputting the high-resolution picture whose resolution is up-converted in said up-converting.

9. The picture decoding method according to claim 8,
wherein said up-converting includes:
estimating a motion vector, per one or more pixels, for a first low-resolution picture from a second low-resolution picture, the first low-resolution picture being decoded in said decoding, and the second low-resolution being decoded in said decoding and having been used as a reference picture in coding of the first low-resolution picture;
obtaining, based on the estimated motion vector, a pixel value of a pixel in a second high-resolution picture which corresponds to the pixel used in said estimating, the second high-resolution picture representing the same image of the second low-resolution picture but having different resolution; and
generating a first high-resolution picture using the obtained pixel value, in order to be outputted as the high-resolution picture in said outputting, the first high-resolution picture representing the same image of the first low-resolution picture but having different resolution.

10. A picture coding device which codes a high-resolution input picture to be one of a high-resolution picture and a low-resolution picture, said device comprising:
a coding control unit operable to decide whether or not a to-be-coded picture is to be coded as a high-resolution picture or a low-resolution picture, depending on a picture type of the to-be-coded picture;
a first down-conversion unit operable to down-convert resolution of the to-be-coded picture, when the to-be-coded picture is decided to be coded as a low-resolution picture in said coding control unit;
a second down-conversion unit operable to down-convert resolution of a reference picture which has been coded as a high-resolution picture, when the reference picture is referred to by the to-be-coded picture decided to be coded as a low-resolution picture in said coding control unit; and
a coding unit operable to code the to-be-coded picture whose resolution is down-converted in said first down-conversion unit, referring to the reference picture whose resolution is down-converted in said second down-conversion unit.

11. A picture decoding device which decodes a bitstream in which each moving picture is coded as a high-resolution picture or a low-resolution picture, said device comprising:
a decoding unit operable to decode a to.-be-decoded picture coded in the bitstream;
a decoded-picture processing unit operable to up-convert resolution of a low-resolution decoded picture to generate a high-resolution picture, when the decoded picture has been coded as a low-resolution picture; and
an output unit operable to output the high-resolution picture whose resolution is up-converted in said decoded-picture processing unit.

12. A program used in a picture coding device which codes a high-resolution input picture to be one of a high-resolution picture and a low-resolution picture, said program causing a computer to execute:
deciding whether or not a to-be-coded picture is to be coded as a high-resolution picture or a low-resolution picture, depending on a picture type of the to-be-coded picture;
down-converting resolution of the to-be-coded picture, when the to-be-coded picture is decided to be coded as a low-resolution picture in said deciding;
down-converting resolution of a reference picture which has been coded as a high-resolution picture, when the reference picture is referred to by the to-be-coded picture decided to be coded as a low-resolution picture in said deciding; and
coding the to-be-coded picture whose resolution is down-converted in said down-converting of the resolution of the to-be-coded picture, referring to the reference picture whose resolution is down-converted in said down-converting of the resolution of the reference picture.

13. A program used in a picture decoding device which decodes a bitstream in which each moving picture is coded as a high-resolution picture or a low-resolution picture, said program causing a computer to execute:
decoding a to-be-decoded picture coded in the bitstream;
up-converting resolution of a low-resolution decoded picture to generate a high-resolution picture, when the decoded picture has been coded as a low-resolution picture; and
outputting the high-resolution picture whose resolution is up-converted in said up-converting.

14. An integrated circuit having a picture coding device which codes a high-resolution input picture to be one of a high-resolution picture and a low-resolution picture, said integrated circuit comprising:
a coding control unit operable to decide whether or not a to-be-coded picture is to be coded as a high-resolution picture or a low-resolution picture, depending on a picture type of the to-be-coded picture;
a first down-conversion unit operable to down-convert resolution of the to-be-coded picture, when the to-be-coded picture is decided to be coded as a low-resolution picture in said coding control unit;
a second down-conversion unit operable to down-convert resolution of a reference picture which has been coded as a high-resolution picture, when the reference picture is referred to by the to-be-coded picture decided to be coded as a low-resolution picture in said coding control unit; and
a coding unit operable to code the to-be-coded picture whose resolution is down-converted in said first down-conversion unit, referring to the reference picture whose resolution is down-converted in said second down-conversion unit.

15. An integrated circuit having a picture decoding device which decodes a bitstream in which each moving picture is coded as a high-resolution picture or a low-resolution picture, said integrated circuit comprising:
a decoding unit operable to decode a to-be-decoded picture coded in the bitstream;
a decoded-picture processing unit operable to up-convert resolution of a low-resolution decoded picture to generate a high-resolution picture, when the decoded picture has been coded as a low-resolution picture; and
an output unit operable to output the high-resolution picture whose resolution is up-converted in said decoded-picture processing unit.
